(19) United States
(12) Patent Application Publication
(10) Pub. No.: US 2024/0369469 A1
(43) Pub. Date: Nov. 7, 2024

(54) OPTICAL ARRANGEMENT FOR COMPENSATION OF THERMALLY-INDUCED ASTIGMATISM OF LENS

(71) Applicant: ILLUMINA, INC., San Diego, CA (US)

(72) Inventors: Dakota Watson, San Diego, CA (US); Joseph Pinto, Solana Beach, CA (US); Peter Newman, San Diego, CA (US)

(21) Appl. No.: 18/652,880

(22) Filed: May 2, 2024

Related U.S. Application Data
(60) Provisional application No. 63/463,601, filed on May 3, 2023.

(51) Int. Cl. G01N 15/1434

(52) U.S. Cl. CPC G01N 15/1436; G01N 2015/1443; G01N 2015/1452

(57) ABSTRACT

An apparatus includes a sample stage region, an optical assembly, and a camera assembly. The optical assembly includes an objective element, a tube lens, and a compensating element. The objective element provides a field of view. at least a portion of the sample stage region is within the field of view. The objective element has a variable astigmatism. The tube lens is configured to receive light transmitted through the objective element and further transmit the light through an image space. The compensating element is in the image space. The compensating element is configured to induce a second astigmatism. The second astigmatism is configured to offset the variable astigmatism. The camera assembly is configured to receive light transmitted from the compensating assembly.

### PRIORITY

This application claims priority to U.S. Provisional Pat. App. No. 63/463,601, entitled “Optical Arrangement for Compensation of Thermally-Induced Astigmatism of Lens,” filed May 3, 2023, the disclosure of which is incorporated by reference herein, in its entirety.

### BACKGROUND

Aspects of the present disclosure relate generally to devices, systems, and methods providing biological or chemical analysis. Various protocols in biological or chemical research involve performing a large number of controlled reactions on local support surfaces or within predefined reaction chambers. The designated reactions may then be observed or detected, and subsequent analysis may help identify or reveal properties of chemicals involved in the reaction. For example, in some multiplex assays, an unknown analyte having an identifiable label (e.g., fluorescent label) may be exposed to thousands of known probes under controlled conditions. Each known probe may be deposited into a corresponding well of a flow cell channel. Observing any chemical reactions that occur between the known probes and the unknown analyte within the wells may help identify or reveal properties of the analyte. Other examples of such protocols include known DNA sequencing processes, such as sequencing-by-synthesis (SBS) or cyclic-array sequencing.

While a variety of devices, systems, and methods have been made and used to perform biological or chemical analysis, it is believed that no one prior to the inventor(s) has made or used the devices and techniques described herein.

### BRIEF DESCRIPTION OF THE DRAWINGS

FIG. 1 depicts a schematic view of an example of a system that may be used to provide biological or chemical analysis.

FIG. 2 depicts a schematic view of an example of a set of components that may cooperate to provide a fluid path in the system of FIG. 1.

FIG. 3 depicts a schematic view of another example of a system that may be used to provide biological or chemical analysis.

FIG. 4 depicts a cross-sectional view of an example of a flow cell that may be used in the system of FIG. 1.

FIG. 5 depicts a cross-sectional view of another example of a flow cell that may be used in the system of FIG. 1.

FIG. 6 depicts a top plan view of the flow cell of FIG. 5, with an upper wafer omitted to reveal a lower wafer.

FIG. 7 depicts a schematic view of another example of a system that may be used to provide biological or chemical analysis.

FIG. 8 depicts a schematic view of an example of imaging components that may be integrated into the system of FIG. 7.

FIG. 9 depicts a schematic view of another example of imaging components that may be integrated into the system of FIG. 7.

FIG. 10 depicts a schematic view of another example of imaging components that may be integrated into the system of FIG. 7.

FIG. 11A depicts a schematic view of an example of an arrangement of imaging components including an example of an astigmatism compensation assembly in a first operational state.

FIG. 11B depicts a schematic view of the arrangement of imaging components of FIG. 11A, with the astigmatism compensation assembly in a second operational state.

FIG. 12 depicts a schematic view of an example of an arrangement of imaging components including an example of an astigmatism compensation assembly and a first example of an actuation arrangement.

FIG. 13 depicts a schematic view of an example of an arrangement of imaging components including an example of an astigmatism compensation assembly and a second example of an actuation arrangement.

FIG. 14A depicts a schematic view of an example of an arrangement of imaging components including another example of an astigmatism compensation assembly in a first operational state.

FIG. 14B depicts a schematic view of the arrangement of imaging components of FIG. 14A, with the astigmatism compensation assembly in a second operational state.

FIG. 15A depicts a schematic view of an example of an arrangement of imaging components including another example of an astigmatism compensation assembly in a first operational state.

FIG. 15B depicts a schematic view of the arrangement of imaging components of FIG. 15A, with the astigmatism compensation assembly in a second operational state.

FIG. 16A depicts a schematic view of an example of an arrangement of imaging components including another example of an astigmatism compensation assembly in a first operational state.

FIG. 16B depicts a schematic view of the arrangement of imaging components of FIG. 16A, with the astigmatism compensation assembly in a second operational state.

FIG. 17 depicts a schematic view of an example of an arrangement of imaging components including another example of an astigmatism compensation assembly.

FIG. 18 depicts a graph representing an example of astigmatism induced by a glass plate as a function of angle of incidence.

FIG. 19 depicts a perspective view of an example of an astigmatism compensation assembly.

FIG. 20 depicts another perspective view of the astigmatism compensation assembly of FIG. 19.

FIG. 21 depicts an exploded perspective view of the astigmatism compensation assembly of FIG. 19.

FIG. 22 depicts another exploded perspective view of the astigmatism compensation assembly of FIG. 19, with housing components omitted for clarity.

FIG. 23A depicts a bottom plan view of the astigmatism compensation assembly of FIG. 19, with housing components omitted for clarity, and with the astigmatism compensation assembly in a first operational state.

FIG. 23B depicts a bottom plan view of the astigmatism compensation assembly of FIG. 19, with housing components omitted for clarity, and with the astigmatism compensation assembly in a second operational state.

FIG. 24A depicts a top plan view of the astigmatism compensation assembly of FIG. 19, with housing components omitted for clarity, and with the astigmatism compensation assembly in the first operational state.

FIG. 24B depicts a top plan view of the astigmatism compensation assembly of FIG. 19, with housing components omitted for clarity, and with the astigmatism compensation assembly in the second operational state.

### DETAILED DESCRIPTION

The following detailed description of certain examples will be better understood when read in conjunction with the appended drawings. To the extent that the figures illustrate diagrams of the functional blocks of various examples, the functional blocks are not necessarily indicative of the division between hardware components. Thus, for example, one or more of the functional blocks (e.g., processors or memories) may be implemented in a single piece of hardware (e.g., a general purpose signal processor or random access memory, hard disk, or the like). Similarly, the programs may be stand-alone programs, may be incorporated as subroutines in an operating system, may be functions in an installed software package, and the like. It should be understood that the various examples are not limited to the arrangements and instrumentality shown in the drawings.

### I. Overview of System for Biological or Chemical Analysis

Examples described herein may be used in various biological or chemical processes and systems for academic analysis, commercial analysis, or other analysis. More specifically, examples described herein may be used in various processes and systems where it is desired to detect an event, property, quality, or characteristic that is indicative of a designated reaction. Bioassay systems such as those described herein may be configured to perform a plurality of designated reactions that may be detected individually or collectively. For example, bioassay systems may be used to sequence a dense array of nucleic acid features through iterative cycles of enzymatic manipulation and image acquisition. In some examples, nucleic acids can be attached to a surface and amplified. Examples of such amplification are described in U.S. Pat. No. 7,741,463, entitled “Method of Preparing Libraries of Template Polynucleotides,” issued Jun. 22, 2010, the disclosure of which is incorporated by reference herein, in its entirety; and/or U.S. Pat. No. 7,270,981, entitled “Recombinase Polymerase Amplification,” issued Sep. 18, 2007, the disclosure of which is incorporated by reference herein, in its entirety.

Components that are used in the bioassay systems may include one or more microfluidic channels that deliver reagents or other reaction components to a reaction site. The reaction sites may be randomly distributed across a substantially planar surface; or may be patterned across a substantially planar surface. Each of the reaction sites may be imaged to detect light from the reaction site. The signals indicating photons emitted from the reaction sites and detected by image sensors may provide illumination values. These illumination values may be combined into an image indicating photons as detected from the reaction sites. These images may be further analyzed to identify compositions, reactions, conditions, etc., at each reaction site.

### II. Examples of Fluidics Devices and Fluid Flow Paths

A. Example of System with Higher Volume Throughput

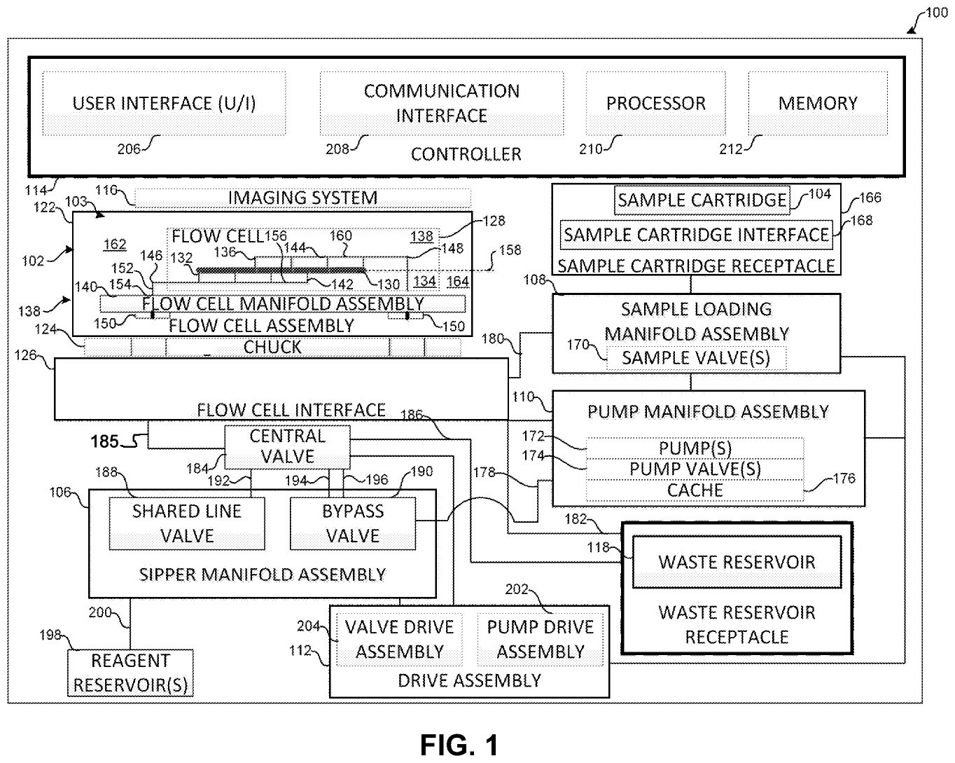

FIG. 1 illustrates a schematic diagram of an example of a system (100) that may be used to perform an analysis on one or more samples of interest. In some implementations, the sample may include one or more clusters of nucleotides (e.g., DNA) that have been linearized to form a single stranded DNA (sstDNA). In the implementation shown, system (100) is configured to receive a flow cell cartridge assembly (102) including a flow cell assembly (103) and a sample cartridge (104). System (100) includes a flow cell receptacle (122) that receives flow cell cartridge assembly (102), a vacuum chuck (124) that supports flow cell assembly (103), and a flow cell interface (126) that is used to establish a fluidic coupling between system (100) and flow cell assembly (103). Flow cell interface (126) may include one or more manifolds. System (100) further includes a sipper manifold assembly (106), a sample loading manifold assembly (108), and a pump manifold assembly (110). System (100) also includes a drive assembly (112), a controller (114), an imaging system (116), and a waste reservoir (118). Controller (114) is electrically and/or communicatively coupled to drive assembly (112) and to imaging system (116); and is configured to cause drive assembly (112) and/or the imaging system (116) to perform various functions as disclosed herein.

In the present example, flow cell assembly (103) includes a flow cell (128) having a channel (130) and defining a plurality of first openings (132), which are fluidically coupled to the channel (130) and arranged on a first side (134) of the channel (130). Flow cell (128) further includes a plurality of second openings (136) fluidically coupled to the channel (130) and arranged on a second side (138) of the channel (130). Fluid may thus flow through flow cell (128) via channel. While the flow cell (128) is shown including one channel (130), flow cell (128) may include two or more channels (130). Flow cell assembly (103) also includes a flow cell manifold assembly (140) coupled to flow cell (128) and having a first manifold fluidic line (142) and a second manifold fluidic line (144). Flow cell manifold assembly (140) may be in the form of a laminate including a plurality of layers as discussed in more detail below.

In the implementation shown, first manifold fluidic line (142) has a first fluidic line opening (146) and is fluidically coupled to each of the first openings (132) of flow cell (128); and second manifold fluidic line (144) has a second fluidic line opening (148) and is fluidically coupled to each of the second openings (136). As shown, flow cell assembly (103) includes gaskets (150) coupled to flow cell manifold assembly (140) and fluidically coupled to fluidic line openings (146, 148). In some implementations where flow cell (128) includes a plurality of channels (130), flow cell manifold assembly (140) may include additional fluidic lines (152) that couple first fluidic line openings (146) to a single manifold port (154). In such implementations, a single gasket (150) may be coupled to flow cell manifold assembly (140) that surrounds the manifold port (154) and is in fluidic communication with a plurality of channels (130). In operation, flow cell interface (126) engages with corresponding gaskets (150) to establish a fluidic coupling between system (100) and flow cell (128). The engagement between flow cell interface (126) and gaskets (150) reduces or eliminates fluid leakage between flow cell interface (126) and flow cell (128).

In the implementation shown, first manifold fluidic line (142) has a portion (156) that is substantially parallel to a longitudinal axis (158) of channel (130); and second manifold fluidic line (144) has a portion (160) that is substantially parallel to longitudinal axis (158) of channel (130). Additionally, first manifold fluidic line (142) is shown being at least partially adjacent a first end (162) of flow cell (128) and spaced from a second end (164) of flow cell (128); and second manifold fluidic line (144) is shown being at least partially adjacent second end (164) of flow cell (128) and spaced from first end (162). Other arrangements of manifold fluidic lines (142, 144) may prove suitable, however.

In the implementation shown, system (100) includes a sample cartridge receptacle (166) that receives sample cartridge (104) that carries one or more samples of interest (e.g., an analyte). System (100) also includes a sample cartridge interface (168) that establishes a fluidic connection with sample cartridge (104). Sample loading manifold assembly (108) includes one or more sample valves (170). Pump manifold assembly (110) includes one or more pumps (172), one or more pump valves (174), and a cache (176). Valves (170, 174) and pumps (172) may take any suitable form. Cache (176) may include a serpentine cache and may temporarily store one or more reaction components during, for example, bypass manipulations of the system (100). While cache (176) is shown being included in pump manifold assembly (110), cache (176) may alternatively be located elsewhere (e.g., in sipper manifold assembly (106) or in another manifold downstream of a bypass fluidic line (178), etc.).

Sample loading manifold assembly (108) and pump manifold assembly (110) flow one or more samples of interest from sample cartridge (104) through a fluidic line (180) toward flow cell cartridge assembly (102). In some implementations, sample loading manifold assembly (108) may individually load or address each channel (130) of flow cell (128) with a respective sample of interest. The process of loading channel (130) with a sample of interest may occur automatically using system (100). As shown in FIG. 1, sample cartridge (104) and sample loading manifold assembly (108) are positioned downstream of flow cell cartridge assembly (102). In the implementation shown, sample loading manifold assembly (108) is coupled between flow cell cartridge assembly (102) and pump manifold assembly (110). To draw a sample of interest from sample cartridge (104) and toward pump manifold assembly (110), sample valves (170), pump valves (174), and/or pumps (172) may be selectively actuated to urge the sample of interest toward pump manifold assembly (110). Sample cartridge (104) may include a plurality of sample reservoirs that are selectively fluidically accessible via the corresponding sample valves (170). To individually flow the sample of interest toward channel (130) of flow cell (128) and away from pump manifold assembly (110), sample valves (170), pump valves (174), and/or pumps (172) may be selectively actuated to urge the sample of interest toward flow cell cartridge assembly (102) and into respective channels (130) of flow cell (128).

Drive assembly (112) interfaces with sipper manifold assembly (106) and pump manifold assembly (110) to flow one or more reagents that interact with the sample within flow cell (128). In some scenarios, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. In the implementation shown, imaging system (116) excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by system (100). Examples of features and functionalities that may be incorporated into imaging system (116) will be described in greater detail below.

After the image data is obtained, drive assembly (112) interfaces with sipper manifold assembly (106) and pump manifold assembly (110) to flow another reaction component (e.g., a reagent) through flow cell (128) that is thereafter received by waste reservoir (118) via a primary waste fluidic line (182) and/or otherwise exhausted by system (100). Some reaction components may perform a flushing operation that chemically cleaves the fluorescent label and the reversible terminator from the sstDNA. The sstDNA may then be ready for another cycle.

The primary waste fluidic line (182) is coupled between pump manifold assembly (110) and waste reservoir (118). In some implementations, pumps (172) and/or pump valves (174) of pump manifold assembly (110) selectively flow the reaction components from flow cell cartridge assembly (102), through fluidic line (180) and sample loading manifold assembly (108) to primary waste fluidic line (182). Flow cell cartridge assembly (102) is coupled to a central valve (184) via flow cell interface (126). Central valve (184) is coupled with flow cell interface (126) via a fluidic line (185). An auxiliary waste fluidic line (186) is coupled to central valve (184) and to waste reservoir (118). In some implementations, auxiliary waste fluidic line (186) receives excess fluid of a sample of interest from flow cell cartridge assembly (102), via central valve (184), and flows the excess fluid of the sample of interest to waste reservoir (118) when back loading the sample of interest into flow cell (128), as described herein.

Sipper manifold assembly (106) includes a shared line valve (188) and a bypass valve (190). Shared line valve (188) may be referred to as a reagent selector valve. Central valve (184) and the valves (188, 190) of sipper manifold assembly (106) may be selectively actuated to control the flow of fluid through fluidic lines (192, 194, 196). Sipper manifold assembly (106) may be coupled to a corresponding number of reagent reservoirs (198) via reagent sippers (200). Reagent reservoirs (198) may contain fluid (e.g., reagent and/or another reaction component). In some implementations, sipper manifold assembly (106) includes a plurality of ports. Each port of sipper manifold assembly (106) may receive one of the reagent sippers (200). Reagent sippers (200) may be referred to as fluidic lines. Some forms of reagent sippers (200) may include an array of sipper tubes extending downwardly along the z-dimension from ports in the body of sipper manifold assembly (106). Reagent reservoirs (198) may be provided in a cartridge, and the tubes of reagent sippers (200) may be configured to be inserted into corresponding reagent reservoirs (198) in the reagent cartridge so that liquid reagent may be drawn from each reagent reservoir (198) into the sipper manifold assembly (106).

Shared line valve (188) of sipper manifold assembly (106) is coupled to central valve (184) via shared reagent fluidic line (196). Different reagents may flow through shared reagent fluidic line (196) at different times. In some versions, when performing a flushing operation before changing between one reagent and another, pump manifold assembly (110) may draw wash buffer through shared reagent fluidic line (196), central valve (184), and flow cell cartridge assembly (102).

Bypass valve (190) of sipper manifold assembly (106) is coupled to central valve (184) via dedicated reagent fluidic lines (194, 196). Each of the dedicated reagent fluidic lines (194, 196) may be associated with a single reagent. The fluids that may flow through dedicated reagent fluidic lines (194, 196) may be used during sequencing operations and may include a cleave reagent, an incorporation reagent, a scan reagent, a cleave wash, and/or a wash buffer.

Bypass valve (190) is also coupled to cache (176) of pump manifold assembly (110) via bypass fluidic line (178). One or more reagent priming operations, hydration operations, mixing operations, and/or transfer operations may be performed using bypass fluidic line (178). The priming operations, the hydration operations, the mixing operations, and/or the transfer operations may be performed independent of flow cell cartridge assembly (102). Thus, the operations using bypass fluidic line (178) may occur during, for example, incubation of one or more samples of interest within flow cell cartridge assembly (102). That is, shared line valve (188) may be utilized independently of bypass valve (190) such that bypass valve (190) may utilize bypass fluidic line (178) and/or cache (176) to perform one or more operations while shared line valve (188) and/or central valve (184) simultaneously, substantially simultaneously, or offset synchronously perform other operations.

Drive assembly (112) includes a pump drive assembly (202) and a valve drive assembly (204). Pump drive assembly (202) may be adapted to interface with one or more pumps (172) to pump fluid through flow cell (128) and/or to load one or more samples of interest into flow cell (128). Valve drive assembly (204) may be adapted to interface with one or more of the valves (170, 174, 184, 188, 190) to control the position of the corresponding valves (170, 174, 184, 188, 190).

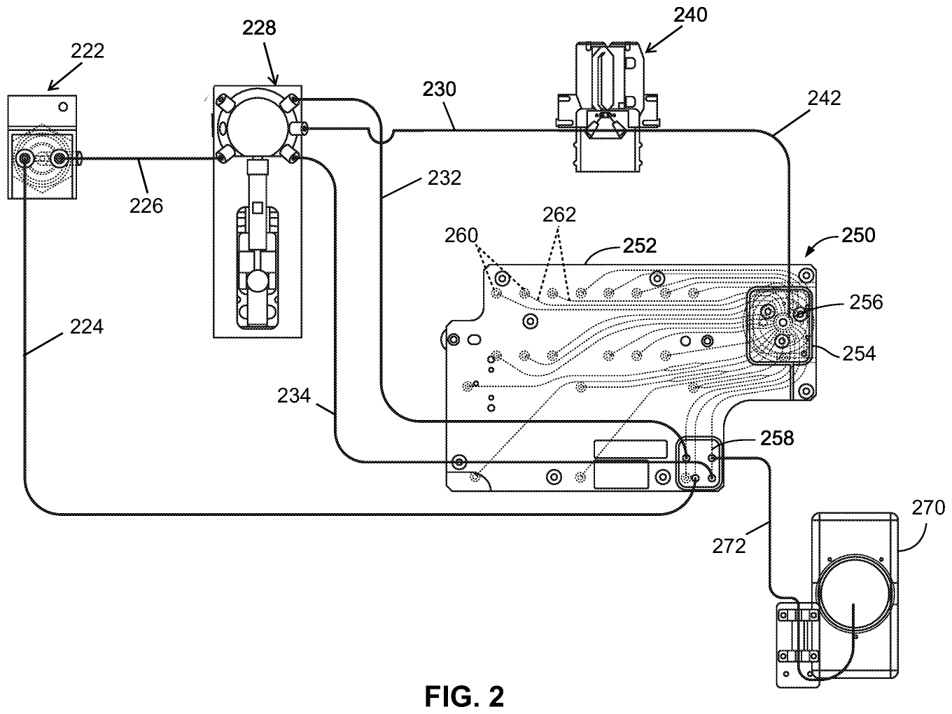

FIG. 2 shows an example of a fluidic arrangement (220) that may be incorporated into a variation of system (100). Fluidic arrangement (220) of this example includes a pump manifold assembly (222), which may operate similar to pump manifold assembly (110) described above; a sample loading manifold assembly (228), which may operate similar to sample loading manifold assembly (108) described above; a flow cell interface (240), which may operate similar to flow cell interface (126) described above; a sipper manifold assembly (250), which may operate similar to sipper manifold assembly (106) described above; and a waste reservoir (270), which may operate similar to waste reservoir (118) described above. Pump manifold assembly (222) is coupled with a port assembly (258) of sipper manifold assembly (250) via a fluidic line (224), which may be similar to fluidic line (178); and with sample loading manifold assembly (228) via a fluidic line (226). Sample loading manifold assembly (228) is coupled with flow cell interface (240) via fluidic line (230), which may be similar to fluidic line (180); and with port assembly (258) via fluidic lines (232, 234). Flow cell interface (240) is coupled with sipper manifold assembly (250) via fluidic line (242), which may be similar to fluidic line (185). Sipper manifold assembly (250) includes a manifold body (252) and a common output port (256), which provides fluid communication via fluidic line (185). A valve assembly (254) controls fluid flow through common output port (256) and may operate similar to central valve (184). Port assembly (258) of sipper manifold assembly (250) is coupled with waste reservoir (270) via fluidic line (272), which may be similar to fluidic line (186).

A plurality of reagent sippers (260) extend from manifold body (252) and are fluidically coupled with valve assembly (254) via respective fluid channels (262) in manifold body (252). Reagent sippers (260) may operate similar to reagent sippers (200). Valve assembly (254) is operable to selectively couple fluid channels (262) with flow cell interface (240) via common output port (256) and fluidic line (230), to thereby selectively provide various reagents to flow cell interface (240). In other words, when each reagent sipper (260) is disposed in a different respective reagent (e.g., in a respective reagent reservoir (198)), a flow cell (e.g., like flow cell (128)) that is coupled with flow cell interface (240) may selectively receive those different reagents based on control of valve assembly (254).

Port assembly (258) may provide a fluidic interface between pump manifold assembly (222) and sipper manifold assembly (250), thereby allowing sipper manifold assembly (250) to receive pressurized fluid from pump manifold assembly (222). Port assembly (258) may also provide a fluidic interface between sample loading manifold assembly (228) and sipper manifold assembly (250), thereby allowing sipper manifold assembly (250) to receive sample fluid from sample loading manifold assembly (228). In addition, port assembly (258) may provide a fluidic interface between waste reservoir (270) and sipper manifold assembly (250), thereby allowing sipper manifold assembly (250) to communicate waste fluid to waste reservoir (270). Communication of fluids via port assembly (258) may be regulated, at least in part, by valve assembly (254).

Referring back to FIG. 1, controller (114) of the present example includes a user interface (206), a communication interface (208), one or more processors (210), and a memory (212) storing instructions executable by the one or more processors (210) to perform various functions including the disclosed implementations. User interface (206), communication interface (133), and memory (212) are electrically and/or communicatively coupled to the one or more processors (210). User interface (206) may be adapted to receive input from a user and to provide information to the user associated with the operation of system (100) and/or an analysis taking place. User interface (206) may include a touch screen, a display, a keyboard, a speaker(s), a mouse, a track ball, and/or a voice recognition system.

Communication interface (208) is adapted to enable communication between system (100) and a remote system(s) (e.g., computers) via a network(s) (e.g., the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc.). Some of the communications provided to the remote system may be associated with analysis results, imaging data, etc. generated or otherwise obtained by system (100). Some of the communications provided to system (100) may be associated with a fluidics analysis operation, patient records, and/or a protocol(s) to be executed by system (100).

The one or more processors (210) and/or system (100) may include one or more of a processor-based system(s) or a microprocessor-based system(s). In some implementations, the one or more processors (210) and/or system (100) includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

Memory (212) may include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

B. Example of System with Lower Volume Throughput

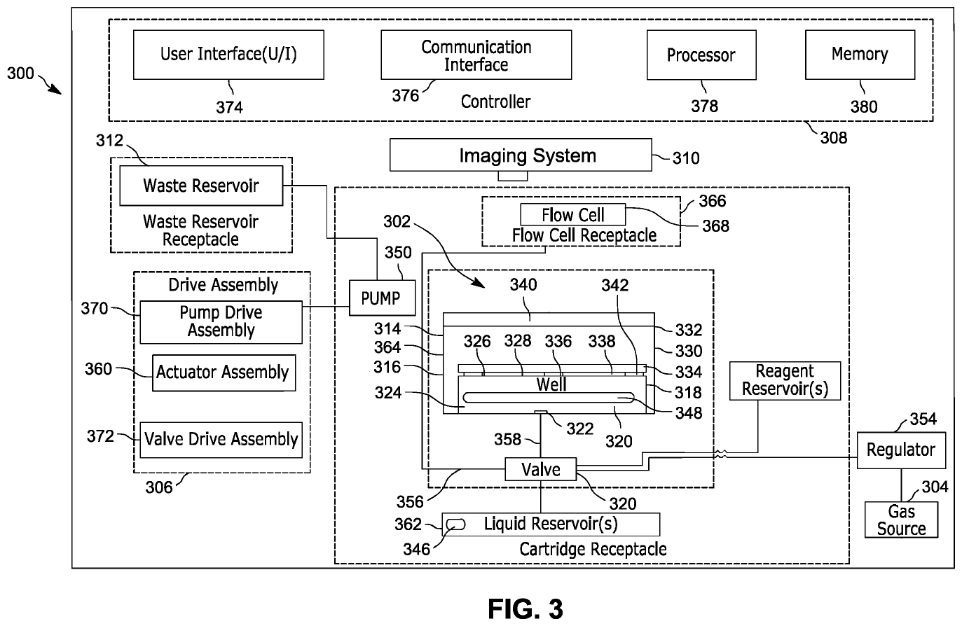

FIG. 3 illustrates a schematic diagram of another example of a system (300) that may be used to perform an analysis on one or more samples of interest. Except as otherwise described below, system (300) of this example may be configured and operable like system (100) described above with reference to FIG. 1. In some instances, system (100) is used to provide a higher volume throughput; while system (300) is used to provide a lower volume throughput. Alternatively, systems (100, 300) may provide any other suitable amount or degree of throughput. System (300) of the present example receives a reagent cartridge (302) and includes, in part, a gas source (304), a drive assembly (306), a controller (308), an imaging system (310), and a waste reservoir (312). Reagent cartridge (302) may be referred to as a consumable, a reagent reservoir, or a reagent assembly. Controller (308) is electrically and/or communicatively coupled to drive assembly (306) and to imaging system (310) and causes drive assembly (306) and/or imaging system (310) to perform various functions as disclosed herein.

Reagent cartridge (302) in the implementation shown includes a well assembly (314) having a body (316). Body (316) has a first wall (318) defining a well (320) having a port (322). First wall (318) has a distal end (324) that defines an opening (326) having an opening perimeter (328). A second wall (330) surrounds first wall (318) and has a distal end (332). Distal end (332) may be referred to as an edge or an outer edge. A cover (334) is coupled to distal end (324) of first wall (318) and covers opening (326) along opening perimeter (328) at a connected portion (336); and is uncoupled from distal end (324) of first wall (318) at an unconnected portion (338). Connection portion (336) may be referred to as connection sections or connected segments and unconnected portion (338) may be referred to as unconnected sections or unconnected segments. First wall (318) has a height and second wall (330) has a height that is greater than the height of first wall (318). First well (318) and second well (330) may alternatively be the same or similar heights. An impermeable barrier (340) is coupled to distal end (332) of second wall (330) and covers well (320). Impermeable barrier (340) may be foil, plastic, etc. and may prevent or inhibit moisture from infiltrating wells (320) of reagent cartridge (302).

Unconnected portion (338) of cover (334) forms a vent (342) that allows air flow out of well (320). Dried reagent (348) is contained within well (320), and vent (342) is sized to substantially retain dried reagent (348) within the well (320). Body (316) may include a plurality of wells (320) while one well (320) is shown in FIG. 3. Liquid (346) may flow into well (320) via port (322) in practice to rehydrate dried reagent (348). Vent (342) may vent gas from well (320) as liquid (346) flows into well (320); and cover (334) prevents or inhibits reagent (348) and/or liquid (346) from escaping from well (320). Put another way, vents (342) retain reagent (348) and/or liquid (346) within wells (320); and prevent or inhibit reagent (348) and/or liquid (346) from migrating out of wells (320). Vent (342) and cover (334) prevent or inhibit cross-contamination between reagents when reagent cartridge (302) includes more than one well (320). Liquid (346) and dried reagent (348) may be flowed into and out of well (320) to mix liquid (346) from liquid reservoir (362) and dried reagent (348). System (300) and/or reagent cartridge (302) may include a mixing chamber that is used to mix liquid (346) and dried reagent (348) in some implementations. Impermeable barrier (340) may be pierced prior to liquid (346) flowing into well (320).

Gas source (304) may be used to pressurize liquid reservoir (362) to flow liquid (346) into well (320); and/or a pump (350) may draw liquid (346) from liquid reservoir (362) and flow liquid (346) into well (320) to rehydrate reagent (348). Gas source (304) may be provided by system (300) and/or may be carried by reagent cartridge (302). Gas source (304) may alternatively be omitted. Pump (350) may be implemented by a syringe pump, a peristaltic pump, a diaphragm pump, etc. While pump (350) may be positioned downstream of flow cell (368) as shown, pump (350) may be positioned upstream of flow cell (368) or omitted entirely.

Reagent cartridge (302) and/or system (300) includes valves (352) that may be selectively actuatable to control the flow of fluid through fluidic lines (356). Such valves (352) may be implemented by a valve manifold, a rotary valve, a selector valve, a pinch valve, a flat valve, a solenoid valve, a check valve, a piezo valve, etc. A regulator (354) may be positioned between gas source (304) and valve (352); and regulate the pressure of the gas provided to valve (352). Regulator (354) may include a valve that controls the flow of the gas from gas source (304).

Body (316) of well assembly (314) has an edge (364); and impermeable barrier (340) may be hermetically connected to body (316) along edge (364). Impermeable barrier (340) may include foil, plastic, and/or any other suitable material(s). System (300) may pierce impermeable barrier (340), impermeable barrier (340) may be pierced by an individual prior to use, or impermeable barrier (340) may be pierced by some other structure or methodology. System (300) includes an actuator assembly (360) in the implementation shown that interfaces with impermeable barrier (340) to pierce impermeable barrier (340). System (300) may include a protrusion such as a post having a blunt or sharp end that is movable by actuator assembly (360) to pierce impermeable barrier (340). Impermeable barrier (340) may alternatively be pierced by an operator prior to reagent cartridge (302) being positioned in system (300). System (300) also includes a liquid reservoir (362) containing liquid (346). Liquid (346) may comprise a rehydrating liquid, a wash buffer, and/or any other suitable kind(s) of liquid.

System (300) further includes a flow cell receptacle (366) that receives a flow cell (368). Flow cell (368) may be configured and operable like flow cell (128). In some variations, flow cell (368) is carried by and/or integrated into reagent cartridge (302). Flow cell (368) may carry the sample of interest. Gas source (304) and/or pump (350) may flow liquid (346) to rehydrate dry reagents (348) and to flow one or more liquid reagents through reagent cartridge (302) that interact with the sample. Imaging system (310) may be configured and operable like imaging system (116), such that imaging system (310) may be used to obtain image data from flow cell (368). After the image data is obtained, drive assembly (306) may interface with reagent cartridge (302) to flow another reaction component (e.g., a reagent) through flow cell (368) that is thereafter received by the waste reservoir (312) and/or otherwise exhausted by reagent cartridge (302). In the present example, drive assembly (306) includes a pump drive assembly (370), a valve drive assembly (372), and actuator assembly (360). Pump drive assembly (370) interfaces with pump (350) to pump fluid through reagent cartridge (302) and/or flow cell (368); and valve drive assembly (372) interfaces with valve (352) to control the position of valve (352).

Controller (308) of this example includes a user interface (374), a communication interface (376), a processor (378), and a memory (380). User interface (374) may be configured and operable like user interface (206) of system (100). Communication interface (376) may be configured and operable like communication interface (208) of system (100). Processor (378) may be configured and operable like processor (210) of system (100). Memory (380) may be configured and operable like memory (212) of system (100).

Further examples and details of how various features of each system (100, 300) may be configured and operable will be described below. By way of further example only, the various features of system (100, 300) may be configured and operable in accordance with at least some of the teachings of International Pub. No. WO 2023/055873, entitled “Flow Cells and Related Flow Cell Manifold Assemblies and Methods,” published Apr. 6, 2023, the disclosure of which is incorporated by reference herein, in its entirety; U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety; and/or U.S. Pat. App. No. 63/325,462, entitled “Well Assemblies and Related Systems and Methods,” filed Mar. 30, 2022, the disclosure of which is incorporated by reference herein, in its entirety.

### III. Examples of Flow Cell Structures

As noted above, a system (100, 300) may execute reactions in a flow cell (128, 368) and/or perform analysis on one or more samples of interest in a flow cell (128, 368). The following describes examples of forms that such flow cells (128, 368) may take, it being understood that flow cells (128, 368) may take various other forms and have various other features in addition to or in lieu of the features described below.

### A. Example of Single-Surface Patterned Flow Cell

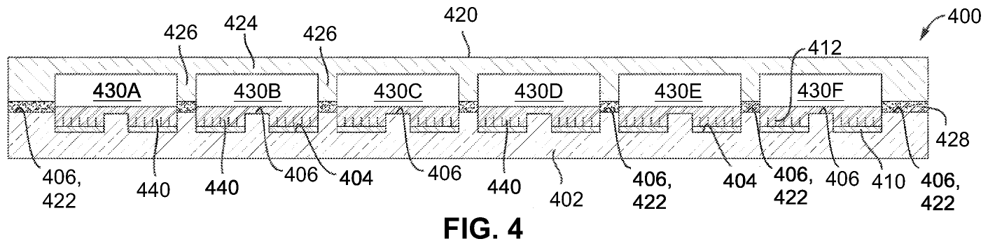

FIG. 4 shows an example of a flow cell (400) that includes a patterned substrate (402), which includes depressions (404) separated by interstitial regions (406), and surface chemistry (410, 412) positioned in the depressions (404). Depressions (404) may be in the form of microwells or nanowells. Depressions (404) may be configured to contain nucleic acid strands or other oligonucleotides and thereby provide a reaction site for SBS and/or for other kinds of processes. In some versions, each depression (404) has a cylindraceous configuration, with a generally circular cross-sectional profile. In some other versions, each depression (404) has a polygonal (e.g., hexagonal, octagonal, square, rectangular, elliptical, etc.) cross-sectional profile. Alternatively, depressions (404) may have any other suitable configuration. It should also be understood that depressions (404) may be arranged in any suitable pattern, including but not limited to a grid pattern.

Surface chemistry (410, 412) of the present example includes functionalized coating layer (410) and primers (412). While not shown, it is to be understood that the depressions (404) may also have surface preparation or treatment chemistry (e.g., silane or a silane derivative) positioned between the substrate (402) and the functionalized coating layer (410). This same surface preparation or treatment chemistry may also be positioned on the interstitial regions (406). In the present example, a hydrogel (440) is applied before lid (420) is bonded to substrate (402). Hydrogel (440) covers surface chemistry (410, 412) in depressions (404), and at least a portion of the patterned substrate (402) (e.g., those interstitial regions (406) that are not also bonding regions (422)). By way of example only, hydrogel (440) may comprise PAZAM, crosslinked polyacrylamide, agarose gel, etc.

Flow cell (400) of this example further includes a lid (420) bonded to bonding region(s) (422) of patterned substrate (402). In the example shown in FIG. 4, lid (420) includes a top portion (424) that is connected to several sidewalls (426), and these components (424, 426) define a portion of each of the six flow channels (430A, 430B, 430C, 430D, 430E, 430F). The respective sidewalls (426) isolate one flow channel (430A, 430B, 430C, 430D, 430E, 430F) from each adjacent flow channel (430A, 430B, 430C, 430D, 430E, 430F). Each flow channel (430A, 430B, 430C, 430D, 430E, 430F) is in selective fluid communication with a respective set of depressions (404).

Lid (420) may be bonded to bonding region (422) of substrate (402) using any suitable technique, such as laser bonding, diffusion bonding, anodic bonding, eutectic bonding, plasma activation bonding, glass frit bonding, or other methods known in the art. In some versions, a spacer layer (428) may be used to bond lid (420) to bonding region (422). Spacer layer (428) may comprise any material that will seal at least some of interstitial regions (404) (e.g., bonding region (422)) of substrate (402) and lid (420) together. While not shown, lid (420) or the patterned substrate (402) may include inlet and outlet ports that are to fluidically engage other ports (not shown), such as those of sample cartridge interface (168), for directing fluid(s) into the respective flow channels (430A, 430B, 430C, 430D, 430E, 430F) (e.g., from a reagent cartridge or other fluid storage system) and out of the flow channel (e.g., to waste reservoir (118) or another waste removal system). Flow channels (430A, 430B, 430C, 430D, 430E, 430F) may serve to, for example, selectively introduce reaction components or reactants to hydrogel (440) and the underlying surface chemistry (410, 412) in order initiate designated reactions in/at depressions (404).

While flow cell (400) includes a pattern of depressions (404) to provide an array of reaction sites, other variations may provide reaction sites on or at various other kinds of structural features, including but not limited to continuously planer surfaces and/or protruding surfaces, etc. By way of further example only, flow cell (400) may be constructed and operable in accordance with at least some of the teachings of U.S. Pat. No. 10,919,033, entitled “Flow Cells with Hydrogel Coating,” issued Feb. 16, 2021, the disclosure of which is incorporated by reference herein, in its entirety.

### B. Example of Dual-Surface Patterned Flow Cell

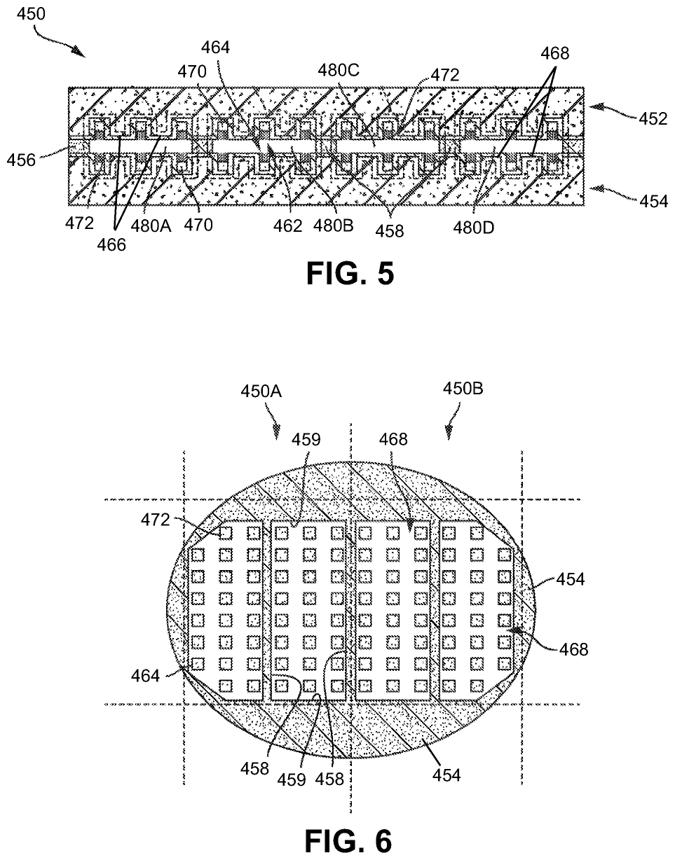

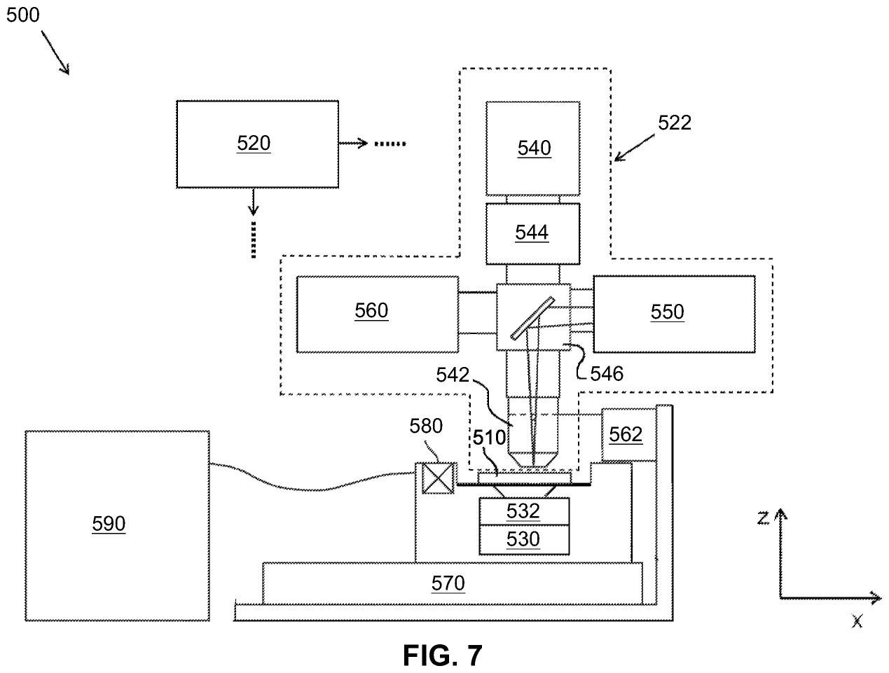

While FIG. 4 shows an example of a flow cell (400) that has a single surface patterned with reaction sites (i.e., depressions (404) formed in substrate (402)), it may be desirable in some instances to provide a variation of flow cell (400) that provide two surfaces patterned with reaction sites. An example of a dual-surface patterned flow cell (450) is shown in FIGS. 5-6. In this example, flow cell (450) includes a pair of wafers (452, 454) that are bonded together, with a spacer layer (456) interposed between wafers (452, 454). Each wafer (452, 454) is patterned to provide a respective plurality of depressions (462, 464), such that depressions (462) of wafer (452) align with depressions (464) of wafer (454) when flow cell (450) is assembled. Depressions (462) are separated from each other by interstitial regions (466); and depressions (464) are separated from each other by interstitial regions (468). Spacer layer (456) does not contact interstitial regions (466, 468) in this example.

Depressions (462, 464) of flow cell (450) may be configured and operable like depressions (404) of flow cell (400) described above. Each depression (462, 464) of the present example includes a grafted coating (470), which may be similar to functionalized coating layer (410); and primers (472), which may be similar to primers (412) described above. Each depression (462, 464) may further include hydrogel, like hydrogel (440), and/or any other suitable feature(s). As shown in FIGS. 5-6, depressions (462, 464) are provided within a plurality of flow channels (480A, 480B, 480C, 480D). Flow channels (480A, 480B, 480C, 480D) are separated from each other by walls (458) and ends (459) formed by spacer layer (456). In the example shown in FIG. 6, flow cell (450) provides four flow channels (480A, 480B, 480C, 480D), with each flow channel (480A, 480B, 480C, 480D) containing several rows and columns of depressions (462, 464). When flow cell (450) is used in system (100, 300), flow channels (480A, 480B, 480C, 480D) may serve to, for example, selectively introduce reaction components or reactants surface chemistry (470, 472) in order initiate designated reactions in/at depressions (462, 464). In some instances, since each wafer (452, 454) has its own set of depressions (462, 464) providing corresponding reaction sites, flow cell (450) may provide twice as many reactions as a similarly sized flow cell (400) during a given time period.

The broken lines in FIG. 6 indicate how flow cell (450) may be diced to effectively form smaller flow cells (450A, 450A), with each smaller flow cell (450A, 450A) having its own respective pair of flow channels (480A, 480B, 480C, 480D). In the present example, however, a single flow cell (450) has more than two flow channels (480A, 480B, 480C, 480D). While flow cell (450) includes a pattern of depressions (462, 464) to provide an array of reaction sites, other variations may provide reaction sites on or at various other kinds of structural features, including but not limited to continuously planer surfaces and/or protruding surfaces, etc. By way of further example only, flow cell (450) may be constructed and operable in accordance with at least some of the teachings of U.S. Pat. No. 10,955,332, entitled “Flow Cell Package and Method for Making the Same,” issued Mar. 23, 2021, the disclosure of which is incorporated by reference herein, in its entirety.

### IV. Examples of Imaging System Features

As noted above, system (100, 300) includes an imaging system (116, 310) that excites one or more identifiable labels (e.g., a fluorescent label) in samples in reaction sites provided by depressions (404, 462, 464) of a flow cell (128, 368, 400, 450); and thereafter obtains image data for the identifiable labels. This image data is used to identify nucleotides as part of a nucleic acid sequencing process. Alternatively, the image data may be used for various other purposes. The following description provides details on how some versions of imaging system (116, 310) may be configured and operable.

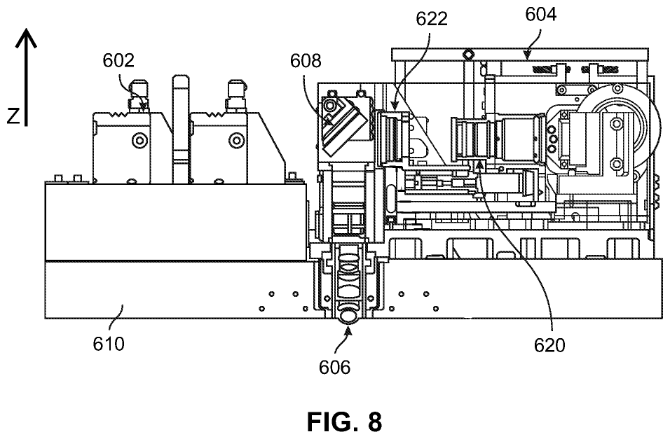

FIG. 7 illustrates a schematic diagram of another example of a system (500) that may be used to perform an analysis on one or more samples of interest. Except as otherwise described below, system (500) of this example may be configured and operable like systems (100, 300) described above. System (500) is configured to perform a large number of parallel reactions within a flow cell (510). Flow cell (510) may be configured and operable like flow cells (400, 450) described above or may have any other suitable configuration. Flow cell (510) may thus include one or more flow channels that receive a solution from system (500) and direct the solution toward reaction sites of flow cell (510).

System (500) includes a system controller (520) that may communicate with the various components, assemblies, and sub-systems of the system (500). Controller (520) may be configured and operable like controllers (114, 308) described above. An imaging assembly (522) of system (500) includes a light emitting assembly (550) that emits light that reaches reaction sites on flow cell (510). Light emitting assembly (550) may include an incoherent light emitter (e.g., emit light beams output by one or more excitation diodes), or a coherent light emitter such as emitter of light output by one or more lasers or laser diodes. In some implementations, light emitting assembly (550) may include a plurality of different light sources (not shown), each light source emitting light of a different wavelength range. Some versions of light emitting assembly (550) may also include one or more collimating lenses (not shown), a light structuring optical assembly (not shown), a projection lens (not shown) that is operable to adjust a structured beam shape and path, epifluorescence microscopy components, and/or other components. Although system (500) is illustrated as having a single light emitting assembly (550), multiple light emitting assemblies (550) may be included in some other implementations.

In the present example, the light from light emitting assembly (550) is directed by dichroic mirror assembly (546) through an objective lens assembly (542) onto a sample of a flow cell (510), which is positioned on a motion stage (570). In the case of fluorescent microscopy of a sample, a fluorescent element associated with the sample of interest fluoresces in response to the excitation light, and the resultant light is collected by objective lens assembly (542) and is directed to an image sensor of camera system (540) to detect the emitted fluorescence. In some implementations, a tube lens assembly may be positioned between the objective lens assembly (542) and the dichroic mirror assembly (546) or between the dichroic mirror (546) and the image sensor of the camera system (540). A moveable lens element may be translatable along a longitudinal axis of the tube lens assembly to account for focusing on an upper interior surface or lower interior surface of the flow cell (510) and/or spherical aberration introduced by movement of the objective lens assembly (542).

In the present example, a filter switching assembly (544) is interposed between dichroic mirror assembly (546) and camera system (540). Filter switching assembly (544) includes one or more emission filters that may be used to pass through particular ranges of emission wavelengths and block (or reflect) other ranges of emission wavelengths. For example, emission filters may be used to direct different wavelength ranges of emitted light to different image sensors of the camera system (540) of imaging assembly (522). For instance, the emission filters may be implemented as dichroic mirrors that direct emission light of different wavelengths from flow cell (510) to different image sensors of camera system (540). In some variations, a projection lens is interposed between filter switching assembly (544) and camera system (540). Filter switching assembly (544) may be omitted in some versions.

System (500) further includes a fluid delivery assembly (590) that may direct the flow of reagents (e.g., fluorescently labeled nucleotides, buffers, enzymes, cleavage reagents, etc.) to (and through) flow cell (510) and waste valve (580). Fluid delivery assembly (590) may be configured and operable like the various fluid delivery components described above in the context of FIGS. 1-3. System (500) of the present example also includes a temperature station actuator (530) and heater/cooler (532) that may optionally regulate the temperature of conditions of the fluids within the flow cell (510). In some implementations, the heater/cooler (532) may be fixed to sample stage (570), upon which the flow cell (510) is placed, and/or may be integrated into sample stage (570).

Flow cell (510) may be removably mounted on sample stage (570), which may provide movement and alignment of flow cell (510) relative to objective lens assembly (542). Sample stage (570) may have one or more actuators to allow sample stage (570) to move in any of three dimensions. For example, actuators may be provided to allow sample stage (570) to move in the x, y, and z directions relative to objective lens assembly (542), tilt relative to objective lens assembly (542), and/or otherwise move relative to objective lens assembly (542). Movement of sample stage (570) may allow one or more sample locations on flow cell (510) to be positioned in optical alignment with objective lens assembly (542). Movement of sample stage (570) relative to objective lens assembly (542) may be achieved by moving sample stage (570) itself, by moving objective lens assembly (542), by moving some other component of imaging assembly (522), by moving some other component of system (500), or any combination of the foregoing. For instance, in some implementations, the sample stage (570) may be actuatable in the x and y directions relative to the objective lens assembly (542) while a focus component (562) or z-stage may move the objective lens assembly (542) along the z direction relative to the sample stage (570).

In some implementations, a focus component (562) may be included to control positioning of one or more elements of objective lens assembly (542) relative to the flow cell (510) in the focus direction (e.g., along the z-axis or z-dimension). Focus component (562) may include one or more actuators physically coupled to the objective lens assembly (542), the optical stage, the sample stage (570), or a combination thereof, to move flow cell (510) on sample stage (570) relative to the objective lens assembly (542) to provide proper focusing for the imaging operation. In the present example, the focus component (562) utilizes a focus tracking module (560) that is configured to detect a displacement of the objective lens assembly (542) relative to a portion of the flow cell (510) and output data indicative of an in-focus position to the focus component (562) or a component thereof or operable to control the focus component (562), such as controller (520), to move the objective lens assembly (542) to position the corresponding portion of the flow cell (510) in focus of the objective lens assembly (542).

In some implementations, an actuator of focus component (562) or for sample stage (570) may be physically coupled to objective lens assembly (542), the optical stage, sample stage (570), or a combination thereof, such as, for example, by mechanical, magnetic, fluidic, or other attachment or contact directly or indirectly to or with the stage or a component thereof. The actuator of focus component (562) may be configured to move objective lens assembly (542) in the z-direction while maintaining sample stage (570) in the same plane (e.g., maintaining a level or horizontal attitude, perpendicular to the optical axis). In some implementations, sample stage (570) includes an x direction actuator and a y direction actuator to form an x-y stage. Sample stage (570) may also be configured to include one or more tip or tilt actuators to tip or tilt sample stage (570) and/or a portion thereof, to account for any slope in its surfaces.

Camera system (540) may include one or more image sensors to monitor and track the imaging (e.g., sequencing) of flow cell (510). Camera system (540) may be implemented, for example, as a CCD or CMOS image sensor camera, but other image sensor technologies (e.g., active pixel sensor) may be used. By way of further example only, camera system (540) may include a dual-sensor time delay integration (TDI) camera, a single-sensor camera, a camera with one or more two-dimensional image sensors, and/or other kinds of camera technologies. While camera system (540) and associated optical components are shown as being positioned above flow cell (510) in FIG. 7, one or more image sensors or other camera components may be incorporated into system (500) in numerous other ways as will be apparent to those skilled in the art in view of the teachings herein. For instance, one or more image sensors may be positioned under flow cell (510), such as within the sample stage (570) or below the sample stage (570); or may even be integrated into flow cell (510).

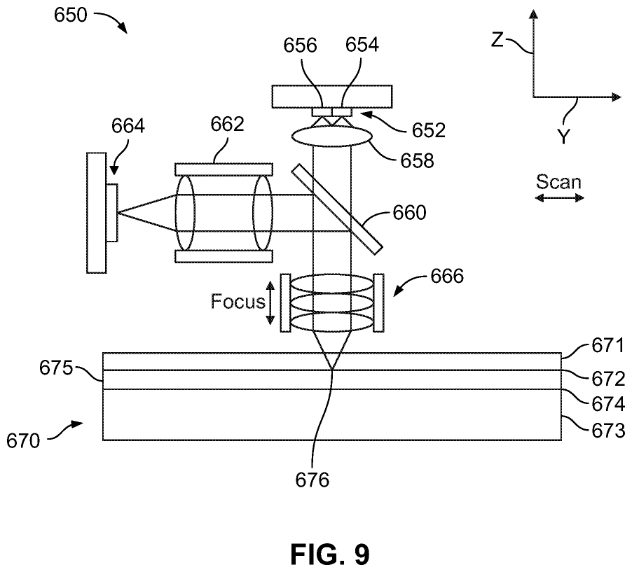

FIG. 8 shows an example of various components that may be integrated into imaging assembly (522) of system (500). In particular, the arrangement shown in FIG. 8 may represent a variation of light emitting assembly (550). The arrangement shown in FIG. 8 may be particularly useful in scenarios where camera system (540) includes a TDI camera. In the arrangement shown in FIG. 8, a line generation module (LGM) (602) and emission optics module (EOM) (604) are aligned and mechanically coupled to precision mounting plate (610), as well as to each other. EOM (604) includes an objective lens assembly (606) that is aligned, via a mirror (608) with a tube lens (620), which in turn is optically coupled to LGM (602). LGM (602) may include one or more light sources (e.g., coherent light sources such as laser diodes). In some examples, LGM (602) may include a first light source configured to emit light in red wavelengths, and a second light source configured to emit light in green wavelengths. LGM (602) may further include optical components, such as focusing surfaces, lenses, reflective surfaces, or mirrors. The optical components may be positioned within an enclosure of LGM (602) to direct and focus the light emitted from the one or more light sources into an adjacent modular subassembly. One or more of the optical components of LGM (602) may also be configured to shape the light emitted from the one or more light sources into desired patterns. For example, in some implementations, the optical components may shape the light into line patterns (e.g., by using one or more Powell lenses, or other beam shaping lenses, diffractive or scattering components). In some variations, LGM (602) may include one or more laser modules which may be individually removed from LGM (602) and replaced.

Light beams generated by LGM (602) transmit through an interface baffle between LGM (602) and EOM (604), pass through objective lens assembly (606), and strike an optical target (e.g., flow cell (510)). In some versions, the interface baffle includes an aperture shaped to enable light to pass through its center, while obscuring interference from external light sources. Responsive light radiation from the target may pass back through objective lens assembly (606) and into tube lens (622). A lens element (622), which may form part of tube lens (620), is configured to articulate along an axis (e.g., a z-axis) to correct for spherical aberration artifacts introduced by objective lens assembly (606) imaging through varied thickness of flow cell (510) components. As illustrated, lens element (622) may be articulated closer to or further away from objective lens assembly (606) to adjust the beam shape and path. Objective lens assembly (606) may emit excitation light toward the optical target (e.g., flow cell (510)) and receive fluorescence emission from the optical target. An actuator may be configured to position objective lens assembly (606) to a region of interest proximate to the optical target. The processor of controller (520) may then execute program instructions for detecting fluorescence emission from the optical target.

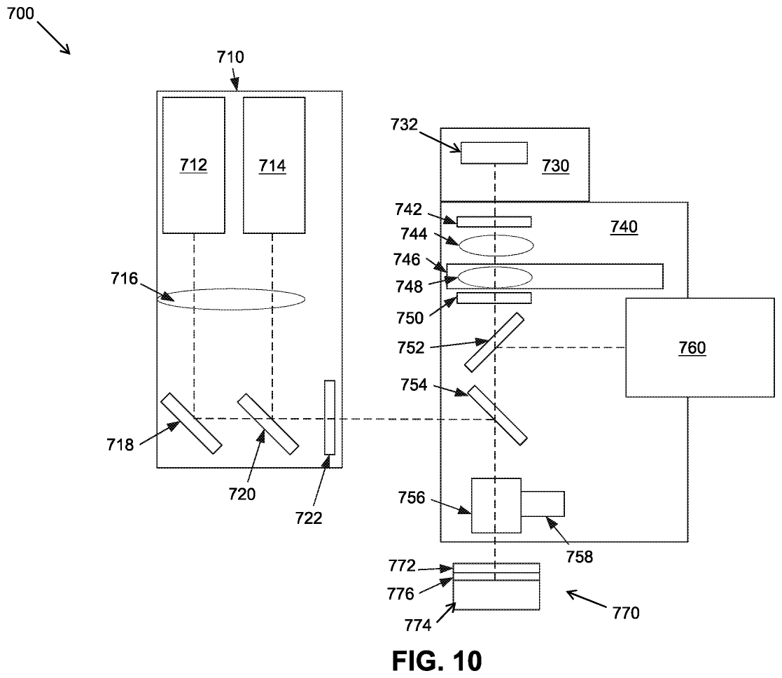

FIG. 9 shows an example of another configuration that may be provided in imaging assembly (522). In particular, FIG. 9 shows an imaging assembly (650) positioned in relation to a flow cell (670). Flow cell (670) may be representative of any of the variations of flow cells (128, 368, 400, 450, 510) described herein. Flow cell (670) has an upper layer (671) and a lower layer (673) that are separated by a fluid filled channel (675). In the configuration shown, upper layer (671) is optically transparent and imaging assembly (650) is focused to an area (676) on inner surface (672) of upper layer (671). In other variations, imaging assembly (650) may be focused on inner surface (674) of lower layer (673). One or both of surfaces (672, 674) may include array features that are to be detected by imaging assembly (650).

Imaging assembly (650) includes an objective lens assembly (666) that is configured to direct excitation radiation from a light emitting assembly (652) to flow cell (670); and to direct emission from flow cell (670) to a detector (664). In the arrangement shown, excitation radiation from light emitting assembly (652) passes through a lens (658), though a beam splitter (660), and through objective lens assembly (666) on to reach flow cell (670). In the present example, light emitting assembly (652) includes two light emitting diodes (LEDs) (656, 654), which produce radiation at different wavelengths from each other. The emission radiation from flow cell (670) is captured by objective lens assembly (666) and is reflected by beam splitter (660) through conditioning optics (662) and to detector (664) (e.g., a CMOS sensor). Beam splitter (660) functions to direct the emission radiation in a direction that is orthogonal to the path of the excitation radiation. The position of objective lens assembly (666) may be moved in the z dimension to alter focus of imaging assembly (650). The imaging assembly (650) may be moved back and forth in the y direction to capture images of several areas of at least one inner surface (672, 674) of flow cell (670).

In the present example, a single imaging assembly (650) includes two LEDs (656, 654) that emit light at two different respective wavelengths, with a single detector (664) detecting light emitted from fluorophore labels in flow cell (670) in response to irradiation at these two different wavelengths. In some other versions, there are two or more imaging assemblies (650), with each imaging assembly (650) including a single LED (656, 654) and a single detector (664), such that each imaging assembly (650) provides irradiation at only one single respective wavelength. As another variation, two or more detectors (664) may receive excitation radiation from a common light emitting assembly (652).

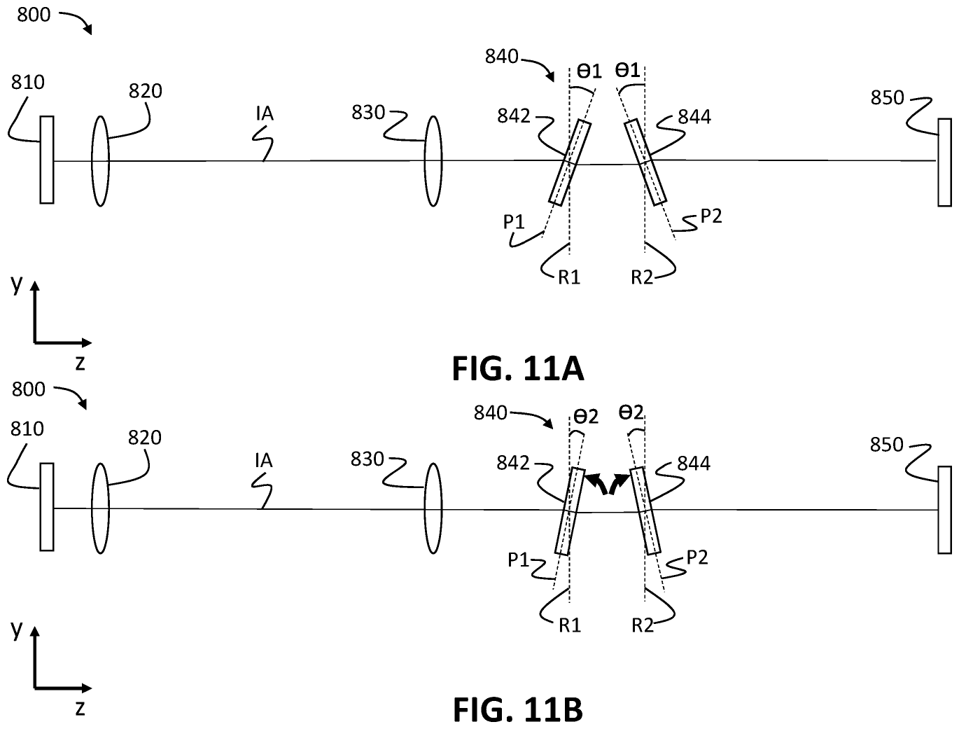

FIG. 10 shows an example of another configuration that may be provided in imaging assembly (522). In particular, FIG. 10 shows an imaging assembly (700) positioned in relation to a flow cell (774). Flow cell (774) may be representative of any of the variations of flow cells (128, 368, 400, 450, 510) described herein. Flow cell (770) has a translucent cover plate (772), a substrate (774), and a liquid layer (776) that is interposed between cover plate (772) and substrate (774). A biological sample may be located on an inside surface of cover plate (772) (above liquid layer (776)) and/or on an inside surface of substrate (774) (below liquid layer (776)).

Imaging assembly (700) of this example includes an LGM (710) with two light sources (712, 714), disposed therein. Light sources (712, 714) may include laser diodes, diode pumped solid state lasers, or other light sources as known in the art, which output laser beams at different wavelengths (e.g., red or green light). The light beams output from light sources (712, 714) are directed through a beam shaping lens or lenses (716). In some implementations, one or more light shaping lenses may be used to shape the light beams output from each or both light sources. LGM (710) may use one or more Powell lenses to spread and/or shape the laser beams from single or near-single mode laser light sources. Other beam shaping optics may be used to control uniformity and increase tolerance such as an active beam expander, an attenuator, one relay lenses, cylindrical lenses, actuated mirrors, diffractive elements, and scattering components. Laser beams may intersect at the back focal point of the objective lens to provide better tolerance on surfaces of flow cell (770).

LGM (710) of this example further includes mirrors (718, 720). A light beam generated by light source (712) reflects off mirror (718), as to be directed through an aperture or semi-reflective surface of mirror (720), and into EOM (740) through a single interface port. Similarly, a light beam generated by light source (714) reflects off of mirror (720) as to be directed into EOM (740) through a single interface port. In some examples, an additional set of articulating mirrors may be incorporated adjacent to mirrors (718, 720) to provide additional tuning surfaces. Both light beams may be combined using dichroic mirror (720). Mirrors (718, 720) may each be configured to articulate using manual or automated controls to align the light beams from light sources (712, 714). The light beams also pass through a shutter element (722) in the present example.

EOM (740) includes an objective lens assembly (756) and a z-stage (758), which moves objective lens assembly (756) longitudinally closer to or further away from flow cell (770). LGM (710) is configured to generate a uniform line illumination through objective lens assembly (756). Z-stage (758) may then move objective lens assembly (756) as to focus the light beams onto either of the inside surfaces of flow cell (770) (e.g., focused on a biological sample). In some implementations, the objective lens assembly (756) may be configured to focus the light beams at a focal point beyond flow cell (770), such as to increase the line width of the light beams at the surfaces of flow cell (770).

EOM (740) of the present example also include a semi-reflective mirror (754) to direct light through objective lens assembly (756), while allowing light returned from flow cell (774) to pass through. EOM (740) further includes a tube lens (744) and a corrective lens (748). Corrective lens (748) may be articulated longitudinally by a z-stage (746), either closer to or further away from objective lens assembly (756), to ensure accurate imaging (e.g., to correct spherical aberration caused by moving objective lens assembly (756); and/or from imaging through a thicker substrate, etc.). Light transmitted through corrective lens (748) and tube lens (744) passes through filter element (742) and into camera system (730). Camera system (730) includes one or more optical sensors (732) to detect light emitted from the biological sample in response to the incident light beams.

In the present example, EOM (740) further includes semi-reflective mirror (752) to reflect a focus tracking light beam emitted from a focus tracking module (FTM) (760) onto flow cell (774), and then to reflect light returned from flow cell (774) back into FTM (760). FTM (760) may include a focus tracking optical sensor to detect characteristics of the returned focus tracking light beam and generate a feedback signal to optimize focus of objective lens assembly (756) on flow cell (774).

The direction, size, and/or polarization of the laser beams may be adjusted by using lenses, mirrors, and/or polarizers. Optical lenses (e.g., cylindrical, spherical, or aspheric) may be used to actively adjust the illumination focus on dual surfaces of the flow cell (770) target. LGM (710) may also include multiple units, with each unit being designed for particular/different wavelengths and polarization. Stacking multiple units may be used to increase the laser power and wavelength options. Two or more laser wavelengths may be combined with dichroics and polarizers.

By way of example only, focus tracking module (560) and/or other components of imaging assembly (522) may be constructed and operable in accordance with at least some of the teachings of U.S. Pat. No. 10,416,428, entitled “Systems and Methods for Improved Focus Tracking Using a Light Source Configuration,” issued Sep. 17, 2019, the disclosure of which is incorporated by reference herein, in its entirety; U.S. Pat. App. No. 63/300,531, entitled “Dynamic Detilt Focus Tracking,” filed Jan. 18, 2022, the disclosure of which is incorporated by reference herein, in its entirety; and/or U.S. Pat. App. No. 63/410,961, entitled “Spot Error Handling for Focus Tracking,” filed Sep. 28, 2022, the disclosure of which is incorporated by reference herein, in its entirety. By way of further example only, components of imaging assembly (522) may be configured and operable in accordance with at least some of the teachings of U.S. Pat. No. 10,774,371, entitled “Laser Line Illuminator for High Throughput Sequencing,” issued Sep. 15, 2020, the disclosure of which is incorporated by reference herein, in its entirety; and/U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety.

### V. Examples of Optical Arrangements for Compensation of Thermally-Induced Astigmatism of Lens

During operation of a system, such as any of the systems (100, 300, 500) described herein, one or more components may tend to heat up, particularly during initial stages of use of the system. In some such scenarios, the heated component may deform or encounter some other structural change, and such deformation or other structural change may affect the performance characteristics of that component. For instance, as noted above, an imaging system (116, 310) or imaging assembly (522, 700) may include an objective lens assembly (542, 606, 666, 756). Such objective lens assemblies (542, 606, 666, 756) may include one or more objective lens elements that heat up during operation of system (100, 300, 500). Such heating of an objective lens element may be caused by heat generated from incident light from light emitting assembly (550, 652), heat generated from incident light from a line generation module (LGM) (602, 710), and/or some other source of heat.

The heating of an objective lens element during operation of a system, such as any of the systems (100, 300, 500) described herein, may tend to dynamically generate an aberration (e.g., astigmatism) in the objective lens element; or otherwise dynamically modify an aberration that is already present in the objective lens element. For instance, heating of the objective lens element may induce changes in the gradient of refractive index and/or coefficient of thermal expansion of the objective lens element; and these physical changes may provide corresponding generation of, or changes in, an astigmatism of the objective lens element. In some cases, such thermal induction or changing of an aberration may tend to occur during an initial heating stage of the objective lens element; and then the generated/modified aberration may tend to substantially stabilize while the objective lens element maintains a substantially steady operating temperature.

As described above, an objective lens assembly (542, 606, 666, 756) may be providing images of reaction sites on flow cell (128, 368, 400, 450, 510) during operation of a system (100, 300, 500), where high image quality is desirable to obtain precise and accurate information about real-time characteristics of small data points (e.g., nucleotides) at the reaction sites. In scenarios where an objective lens element has a dynamically changing aberration profile, the dynamically changing aberration profile may tend to dynamically affect the image quality in an adverse way, unless there is some kind of dynamic compensation for the dynamically changing aberration profile. To the extent that it may be possible to provide some degree of dynamic compensation for a thermally induced dynamically changing aberration profile of an objective lens element through image processing techniques, it may be desirable to provide an optical, hardware-based solution to provide dynamic compensation for a thermally induced dynamically changing aberration profile of an objective lens element. The following describes several examples of optical solutions that may be used to provide dynamic compensation for a thermally induced dynamically changing aberration profile of an objective lens element.

A. Examples of Optical Arrangements with Dual Pivoting Compensation Elements

### 1. Overview

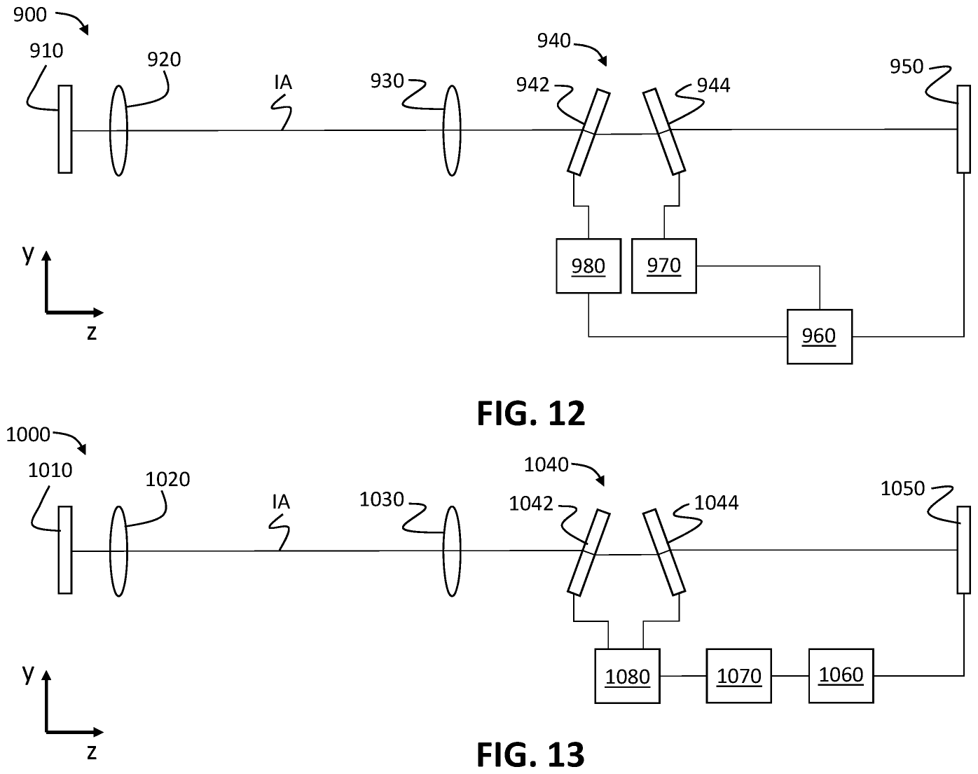

FIGS. 11A-11B show an example of an arrangement (800) that may be integrated into imaging system (116, 310) or imaging assembly (522, 700). Arrangement (800) of this example includes a flow cell (810), an objective lens element (820), a tube lens (830), a compensation assembly (840), and a camera (850). Objective lens element (820) is positioned over flow cell (810), which may be configured and operable like any of the variations of flow cells (128, 368, 400, 450, 510) described herein. In the present example, florescent labels at reaction sites on flow cell (810) emit light in response to excitation from one or more excitation light sources (not shown); and an emission beam is transmitted from flow cell (810) through objective lens element (820) to tube lens (830). In addition to the emission beam passing through objective lens element (820), the excitation beam may also pass through objective lens element (820) to reach flow cell (820). This excitation beam may cause heating of objective lens element (820) as described herein. As further described herein, this excitation beam may be emitted from light emitting assembly (550, 652), from line generation module (LGM) (602, 710), or from some other source of light.

The emission beam from flow cell (810) is generally emitted along an image axis (IA), with objective lens element (820) being centered along the image axis (IA). The image axis (IA) is parallel to the z-axis in the present example. Objective lens element (820) of this example is configured to substantially collimate the emission beam. While just one objective lens element (820) is shown in this example, such representation is only intended as a schematic representation. It should be understood that objective lens element (820) may in fact comprise a lens assembly that is formed by a plurality of lens elements and/or other optical features.

Tube lens (830) is also centered along the image axis (IA) such that the collimated emission beam from objective lens element (820) passes through tube lens (830) into a converging image space. While just one lens element is shown to represent tube lens (830) in this example, such representation is only intended as a schematic representation. It should be understood that tube lens (820) may in fact comprise a lens assembly that is formed by a plurality of lens elements and/or other optical features.

Compensation assembly (840) is positioned on the image axis (IA) in the converging image space between tube lens (830) and camera (850). Compensation assembly (840) of this example includes a first compensation plate (842) and a second compensation plate (844). In this example, each compensation plate (842, 844) comprises a flat plate formed of an optically transmissive material (e.g., glass); though other configurations may be used. First compensation plate (842) is located at a longitudinal positioned along the image axis (IA) where a first perpendicular reference plane (R1) intersects the image axis (IA). Second compensation plate (844) is located at a longitudinal positioned along the image axis (IA) where a second perpendicular reference plane (R2) intersects the image axis (IA). Thus, first compensation plate (842) is longitudinally interposed between second compensation plate (844) and tube lens (830); while second compensation plate (844) is longitudinally interposed between first compensation plate (842) and camera (850).

In the present example first compensation plate (842) has the same structural configuration as second compensation plate (844), such that compensation plates (842, 844) have an identical material composition, thickness, etc. However, compensation plates (842, 844) are positioned at different angular orientations along the image axis (IA). In particular, in the state of operation shown in FIG. 11A, first compensation plate (842) is positioned along a first plate plane (P1) that is tilted at a first tilt angle (θ1) relative to the first reference plane (R1) in a clockwise direction about a tilt axis that is parallel with the x-axis. At the same state of operation shown in FIG. 11A, second compensation plate (844) is positioned along a second plate plane (P2) that is tilted at the first tilt angle (θ1) relative to the second reference plane (R2) in a counterclockwise direction about a tilt axis that is parallel with the x-axis. In other words, compensation plates (842, 844) are oriented at equal and opposing tilt angles about respective tilt axes that are parallel with the x-axis.

Compensation assembly (840) is configured to compensate for any astigmatisms that may be provided by the combination of objective lens element (820) and tube lens (830). In particular, first compensation plate (842) may be configured to induce a first astigmatism that partially offsets the astigmatism that is provided by the combination of objective lens element (820) and tube lens (830); while second compensation plate (842) is configured to induce a second astigmatism that completes the offset of the astigmatism that is provided by the combination of objective lens element (820) and tube lens (830). The first astigmatism induced by first compensation plate (842) may be a function of the thickness, refractive index, and angle of incidence (based on tilt angle (θ)) of first compensation plate (842); the second astigmatism induced by second compensation plate (844) may be a function of the thickness, refractive index, and angle of incidence (based on tilt angle (θ)) of second compensation plate (844).

After the emitted light passes through first compensation plate (842), the image axis (IA) may tend to shift slightly in a first direction along the y-dimension; and then shift slightly again in a second direction along the y-dimension after passing through second compensation plate (844). This shift is not depicted in FIG. 11A. In the present example, since compensation plates (842, 844) are oriented at equal and opposing tilt angles, the image shift caused by second compensation plate (844) is equal and opposite to the image shift caused by first compensation plate (842). Thus, the image axis (IA) in the space between second compensation plate (844) and camera (850) is aligned with the image axis (IA) in the space between flow cell (810) and first compensation plate (842).

It should be understood from the foregoing that compensation plates (842, 844) cooperate to offset or compensate for any astigmatisms that may be provided by the combination of objective lens element (820) and tube lens (830); while also providing the image from flow cell (810) to camera (850) along an aligned image axis (IA). Camera (850) captures the image transmitted from compensation assembly (840). Camera (850) may be configured and operable like any of the camera systems (540, 730) described herein; and may comprise a CCD or CMOS image sensor camera, an active pixel sensor camera, a dual-sensor time delay integration (TDI) camera, a single-sensor camera, a camera with one or more two-dimensional image sensors, and/or other kinds of camera technologies. Images captured with camera (850) may be analyzed to evaluate characteristics of reaction sites on flow cell (810) as described herein.

As noted above, the temperature of objective lens element (820) may have a first value before the excitation light is activated and incident upon objective lens element (820). After the excitation light is activated and incident upon objective lens element (820) during an initial stage of operation, the temperature of objective lens element (820) may rise and eventually stabilize at or around a second temperature value. The temperature of objective lens element (820) may remain substantially constant at or around the second temperature value during continued operation, as the excitation light remains activated and incident upon objective lens element (820). As also noted above, as the temperature of objective lens element (820) rises from the first temperature to the second temperature, the rise in temperature may generate or change an aberration in objective lens element (820), such as an astigmatism. In other words, objective lens element (820) may have a thermally induced dynamic aberration during the initial heating period. In the present example, the temperature of tube lens (830) does not substantially change during operation, such that any changes in aberrations of tube lens (830) during operation may be considered negligible. In some other versions, temperature changes may induce or otherwise change aberrations in tube lens (830) and/or in other optical components of imaging system (116, 310) or imaging assembly (522, 700).

Since compensation assembly (840) is configured to offset or compensate for any astigmatisms that may be provided by the combination of objective lens element (820) and tube lens (830), it may be necessary to dynamically adjust compensation assembly (840) to “keep up” with the thermally induced dynamic aberration of objective lens element (820) and/or other optical components during the initial heating period. In other words, it may be desirable to provide dynamic adjustments to compensation assembly (840) to thereby dynamically offset or compensate for the thermally induced dynamic aberration of objective lens element (820) and/or other optical components during the initial heating period. Such adjustments may be performed by pivoting each compensation plate (842, 844) about its respective pivot axis, as the offsetting astigmatism of each compensation plate (842, 844) may be a function of the tilt angle tilt angle (θ) of each compensation plate (842, 844).

While the examples herein are provided in the context of dynamic aberrations of objective lens element (820), the teachings herein may also be applied to scenarios where one or more other optical components of imaging system (116, 310) or imaging assembly (522, 700) provide dynamic aberrations (regardless of whether objective lens element (820) also provides dynamic aberrations or does not provide dynamic aberrations). In other words, the teachings herein are not necessarily dependent on objective lens element (820) being the source of dynamic aberrations. Compensation plates (842, 844) may be utilized to correct for aberrations from any source that might otherwise reach camera (850).

FIGS. 11A-11B together show an example of pivotal movement of compensation plates (842, 844) to simultaneously adjust the tilt angle (θ) of each compensation plate (842, 844). In FIG. 11A, first compensation plate (842) is tilted at a first tilt angle (θ1) about its tilt axis in a clockwise direction relative to first reference plane (R1); while second compensation plate (844) is tilted at the first tilt angle (θ1) about its own tilt axis in a counterclockwise direction relative to second reference plane (R2). In FIG. 11B, first compensation plate (842) is tilted at a second tilt angle (θ2) about its tilt axis in a clockwise direction relative to first reference plane (R1); while second compensation plate (844) is tilted at the second tilt angle (θ2) about its own tilt axis in a counterclockwise direction relative to second reference plane (R2). Thus, compensation plates (842, 844) are pivoted about their respective tilt axes, in opposite angular directions, to transition from first tilt angle (θ1) to second tilt angle (θ2). The astigmatisms respectively induced by compensation plates (842, 844) will be different at the second tilt angle (θ2) as compared to the astigmatisms respectively induced by compensation plates (842, 844) at the first tilt angle (θ1). This is due to the difference in the angle of incidence on compensation plates (842, 844) at the second tilt angle (θ2) relative to the angle of incidence on compensation plates (842, 844) at the first tilt angle (θ1), as the induced astigmatism is influenced at least in part by the angle of incidence.

In some scenarios, the astigmatisms respectively induced by compensation plates (842, 844) at the first tilt angle (θ1) offset the astigmatisms provided by the combination of objective lens element (820) and tube lens (830) at the initial, lower temperature; while the astigmatisms respectively induced by compensation plates (842, 844) at the second tilt angle (θ2) offset the astigmatisms provided by the combination of objective lens element (820) and tube lens (830) at the operating, higher temperature. The rate at which compensation plates (842, 844) pivot from the first tilt angle (θ1) to the second tilt angle (θ2) may be selected to track the rate at which the astigmatism provided by the combination of objective lens element (820) and tube lens (830) changes due to the rise in temperature of objective lens element (820). In other words, as compensation plates (842, 844) pivot from the first tilt angle (θ1) to the second tilt angle (θ2), compensation assembly (840) may dynamically compensate for the dynamic changes in astigmatism provided by the combination of objective lens element (820) and tube lens (830) while objective lens element (820) heats up. To the extent that the temperature of objective lens element (820) remains substantially stable after heating up to a normal operating temperature, compensation plates (842, 844) may remain fixed at the second tilt angle (θ2) such that compensation assembly (840) maintains a fixed astigmatism offset.

It should be understood that, as compensation plates (842, 844) pivot from the first tilt angle (θ1) to the second tilt angle (θ2), the image shift caused by compensation plates (842, 844) along the y-dimension may move along the y-dimension accordingly. However, since compensation plates (842, 844) rotate in opposite directions about parallel axes and at the same rate, the light may continue to be centered along the aligned image axis (IA) in the space between second compensation plate (844) and camera (850). While compensation plates (842, 844) rotate simultaneously in opposite directions about parallel axes and at the same rate in some versions, there may be scenarios where one compensation plate (842, 844) pivots independently relative to the other compensation plate (842, 844). Such independent pivoting of a single compensation plate (842, 844) (e.g., while the other compensation plate (842, 844) remains stationary) may be provided to adjust the beam position in the y-direction to maintain desired alignment of the beam axis onto the image sensor of camera (850).

It should also be understood that compensation assembly (840) may be positioned anywhere along the image axis (IA) within the converging image space between tube lens (830) and camera (850). Thus, compensation assembly (840) may be positioned closer to tube lens (830) than is shown in FIGS. 11A-11B or closer to camera (850) than is shown in FIGS. 11A-11B. Moreover, compensation plates (842, 844) may be positioned apart from each other by any suitable distance.

### 2. Examples of Methods of Operating Compensation Assembly

Some versions of arrangement (800) may provide tracking of the thermally-induced or thermally-changed astigmatism of objective lens element (820) in real time; and dynamically adjust the tilt angle (θ) of compensation plates (842, 844) in real-time through a feedback loop. In some such cases, the real-time tracking of the changes in the thermally-induced or thermally-changed astigmatism of objective lens element (820) may be achieved using image processing techniques. For instance, an algorithm executed through a controller (114, 308, 520) may provide analysis of images captured by camera (850) during the initial stages of operation while objective lens element (820) heats up from an initial, resting temperature to a normal, stable operating temperature to thereby track the thermally-induced or thermally-changed astigmatism of objective lens element (820) in real time. By way of example only, the image analysis algorithm may track full width at half maximum (FWHM) values associated with captured images along the x-dimension and FWHM values associated with captured images along the y-dimension to evaluate the astigmatism of objective lens element (820). The same algorithm may further drive one or more actuators, etc., to provide pivotal movement of compensation plates (842, 844) in real-time through a feedback loop, based on the tracked astigmatism of objective lens element (820). In some versions where a real-time feedback loop is used to drive pivotal movement of compensation plates (842, 844), such pivotal movement of compensation plates (842, 844) may vary each time arrangement (800) is used, to the extent that the dynamically changing aberration profile of objective lens element (820) may vary among different uses of arrangement (800) (e.g., due to environmental factors, age of equipment factors, different kinds of excitation light profiles being used, etc.).

As an alternative to using an ad hoc real-time feedback loop to drive pivotal movement of compensation plates (842, 844) each time arrangement is used (800), the pivotal movement of compensation plates (842, 844) may be provided based on a predetermined adjustment profile. In other words, a controller (114, 308, 520) need not process captured images to track the changes in the thermally-induced or thermally-changed astigmatism of objective lens element (820) every time arrangement (800) is used. Instead, controller (114, 308, 520) may simply be programmed with the predetermined adjustment profile; and may simply execute that predetermined adjustment profile on a consistent basis each time arrangement (800) is used. The predetermined adjustment profile may be established through a calibration process. This calibration process may take place at a facility where arrangement (800) is manufactured. Alternatively, the calibration process may take place at the location where arrangement (800) will ultimately be used, such as during an initialization process the first time arrangement (800) is used by the consumer.

Regardless of where the calibration process takes place, the calibration process may include a sequence of allowing objective lens element (820) to heat up from an initial, resting temperature to a normal, stable operating temperature, tracking the dynamic astigmatism of objective lens element (820) in real time through image processing techniques as described above, and driving pivotal movement of compensation plates (842, 844) based on the tracked dynamic astigmatism of objective lens element (820). In some cases, after a first calibration run, controller (114, 308, 520) may deactivate the source of excitation light and allow the temperature of objective lens element (820) to return back to the initial, resting temperature; then repeat the process to perform a second calibration run. This may be repeated as many times as desired. Controller (114, 308, 520) may ultimately determine the best adjustment profile for pivotal movement of compensation plates (842, 844) and thereby establish that best adjustment profile as the predetermined adjustment profile for subsequent uses of arrangement (800).

3. Example of Compensation Assembly with Dual Actuators

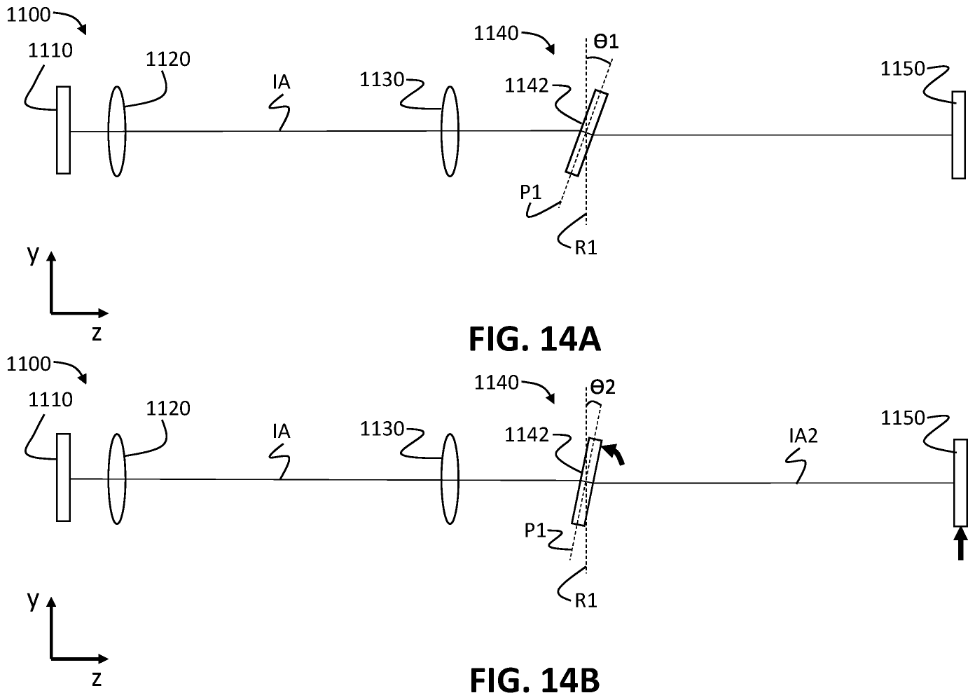

FIG. 12 shows an example of an arrangement (900) where dual actuators (970, 980) are used to drive a compensation assembly (940). Arrangement (900) is substantially identical to arrangement (800) except as otherwise described below. Arrangement (900) includes a flow cell (910), an objective lens element (920), a tube lens (930), a compensation assembly (940), and a camera (950). Compensation assembly (940) includes a first compensation plate (942) and a second compensation plate (944). Arrangement (900) of this example differs from arrangement (800) in that arrangement (900) is shown as including a controller (960), a first actuator (980), and a second actuator (970). Controller (960) may be configured and operable like any other controller (114, 308, 520) described herein, such that controller (960) is operable to process images captured by camera (950), process other data, and control operation of other components. To that end, controller (960) is also operable to control actuators (970, 980) by activating actuators (970, 980) to drive movement of compensation plates (942, 944) as described herein.

First actuator (980) is coupled with first compensation plate (942), such that first actuator (980) is operable to drive pivotal movement of first compensation plate (942). Second actuator (970) is coupled with second compensation plate (944), such that second actuator (970) is operable to drive pivotal movement of second compensation plate (944). In some versions, each actuator (970, 980) comprises a motor, such that activation of actuator (970, 980) cases a drive shaft of the motor to rotate and thereby drive pivotal movement of compensation plate (942, 944). In some other versions, each actuator (970, 980) comprises a solenoid or voice coil. Alternatively, actuators (970, 980) may take any other suitable form. In the present example, each compensation plate (942, 944) has its own dedicated actuator (970, 980), such that it is theoretically possible to activate actuators (970, 980) independently and thereby drive pivotal movement of compensation plates (942, 944) independently. For instance, there may be scenarios where one compensation plate (942, 944) is pivoted independently relative to the other compensation plate (942, 944). Such independent pivoting of a single compensation plate (942, 944) (e.g., while the other compensation plate (942, 944) remains stationary) may be provided to adjust the beam position in the y-direction to maintain desired alignment of the beam axis onto the image sensor of camera (950). However, in the present example, controller (960) is configured to activate actuators (970, 980) in synchronization with each other.

4. Example of Compensation Assembly with Single Actuator and Linkage

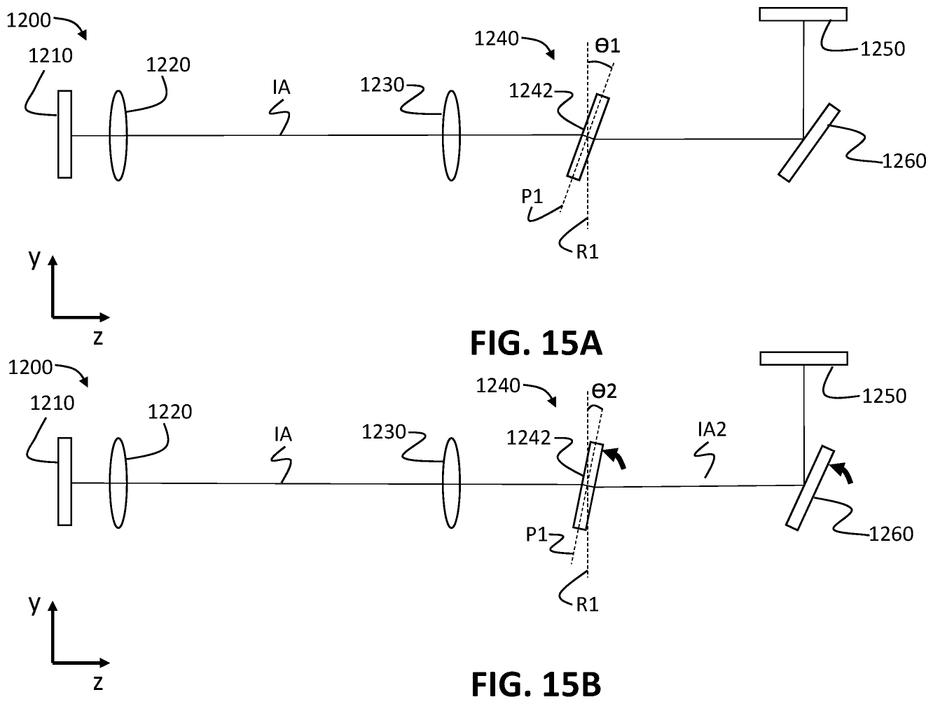

FIG. 13 shows an example of an arrangement (1000) where a single dual actuator (1070) is used to drive a compensation assembly (1040). Arrangement (1000) is substantially identical to arrangement (800) except as otherwise described below. Arrangement (1000) includes a flow cell (1010), an objective lens element (1020), a tube lens (1030), a compensation assembly (1040), and a camera (1050). Compensation assembly (1040) includes a first compensation plate (1042) and a second compensation plate (1044). Arrangement (1000) of this example differs from arrangement (1000) in that arrangement (1000) is shown as including a controller (1060), an actuator (1070), and a linkage (1080). Controller (1060) may be configured and operable like any other controller (114, 308, 520) described herein, such that controller (1060) is operable to process images captured by camera (1050), process other data, and control operation of other components. To that end, controller (1060) is also operable to control actuator (1070) by activating actuator (1070) to drive movement of compensation plates (1042, 1044) as described herein.

Linkage (1080) is coupled with actuator (1070) and with both compensation plates (1042, 1044). Linkage (1080) of the present example comprises a mechanical assembly that is configured to drive simultaneous, synchronized pivotal movement of compensation plates (1042, 1044) in opposite directions when linkage (1080) is activated by actuator (1070). By way of example only, linkage (1080) may comprise a plurality of rods, bars, or other links that are pivotally joined together. By way of further example only, linkage (1080) may comprise a plurality of gears that are meshed together. By way of further example only, linkage (1080) may comprise a set of cams providing a combination of engaged driving surfaces and bearing surfaces. Alternatively, linkage (1080) may take any other suitable form. Similarly, actuator (1070) may take any suitable form, including but not limited to a motor, a solenoid, a voice coil, etc.

B. Examples of Optical Arrangements with Single Pivoting Compensation Elements

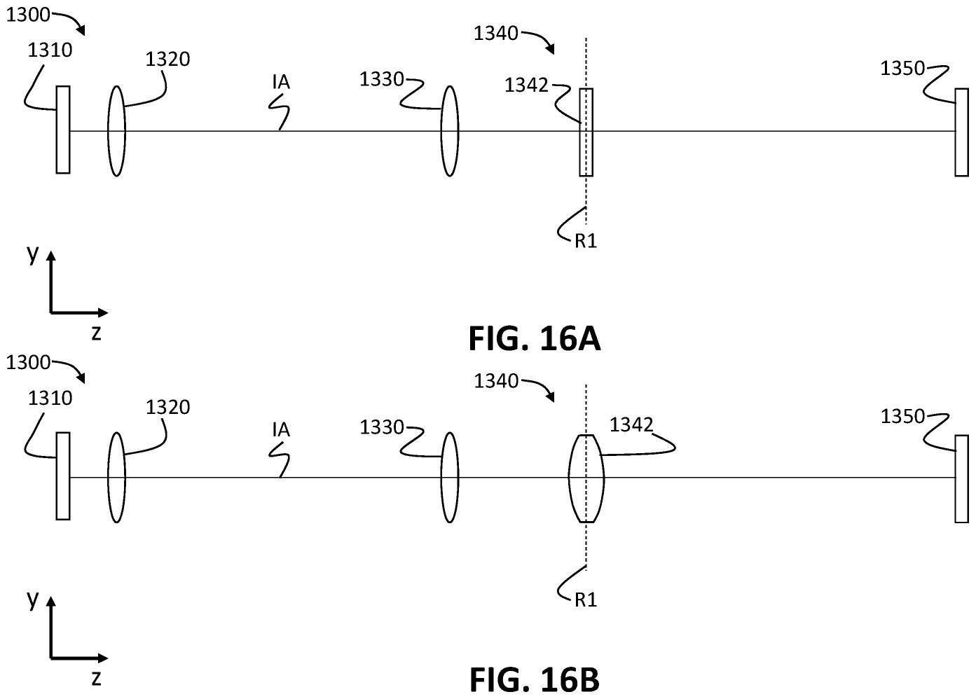

In some scenarios, it may be desirable to provide a variation of compensation assembly (840, 940, 1040) with just one compensation element. FIGS. 14A-14B show an example of such an arrangement (1100). Arrangement (1100) of this example includes a flow cell (1110), an objective lens element (1120), a tube lens (1130), a compensation assembly (1140), and a camera (1150). Flow cell (1110), objective lens element (1120), tube lens (1130), and camera (1150) may be configured and operable like flow cell (810), objective lens element (820), tube lens (830), and camera (850) as described above. Compensation assembly (1140) may be configured and operable like compensation assembly (840), except as otherwise described below.

Compensation assembly (1140) of this example includes just one compensation plate (1142). Like compensation plates (842, 844), compensation plate (1142) is configured to (by itself) compensate for any astigmatisms that may be provided by the combination of objective lens element (1120) and tube lens (1130). Similarly, compensation plate (1142) is rotatable about a pivot axis among different tilt angles (θ1, θ2) to adjust its own astigmatism, to thereby dynamically compensate for the thermally induced changes in the astigmatism of objective lens element (1120) as objective lens element (1120) heats up from an initial, resting temperature to a normal, stable operating temperature. However, since there is only one compensation plate (1142) in compensation assembly (1140), the image axis (IA) will shift along the y-dimension as compensation plate (1142) pivots about the pivot axis that is parallel to the z-axis. This shift is shown in FIG. 14B, where the image axis (IA2) in the space between compensation plate (1142) and camera (1150) is shifted relative to the image axis (IA) in the space between flow cell (1110) and compensation plate (1142). It should be understood that the shift shown in the transition from FIG. 14A to FIG. 14B may be considered exaggerated for purposes of illustration.

In arrangement (1100) of the present example, the shift in the image axis (IA, IA2) is accounted for by movement of camera (1150), such that camera (1150) moves with the image axis (IA, IA2) to remain centered along the image axis (IA2). This movement of camera (1150) is shown in the transition from FIG. 14A to FIG. 14B. Such movement of camera (1150) may be provided in various ways. By way of example only, a dedicated actuator (not shown) may drive movement of camera (1150) along the y-dimension. Such an actuator may be configured and operable in like any of the other actuators (970, 980, 1070) described herein. As another variation a single actuator (not shown) may be coupled with a linkage (not shown); and that linkage may be coupled with both compensation plate (1142) and camera (1150). As another variation, camera (1150) may be sized and configured to tolerate the image movement due to compensation plate (1142) motion. The combination of the actuator and the linkage may provide simultaneous, synchronized movement of compensation plate (1142) and camera (1150). The linkage may be configured and operable similar to linkage (1080) described above. Alternatively, pivotal movement of compensation plate (1142) may be provided in any other suitable fashion; and movement of camera (1150) in the y-dimension may be provided in any other suitable fashion.

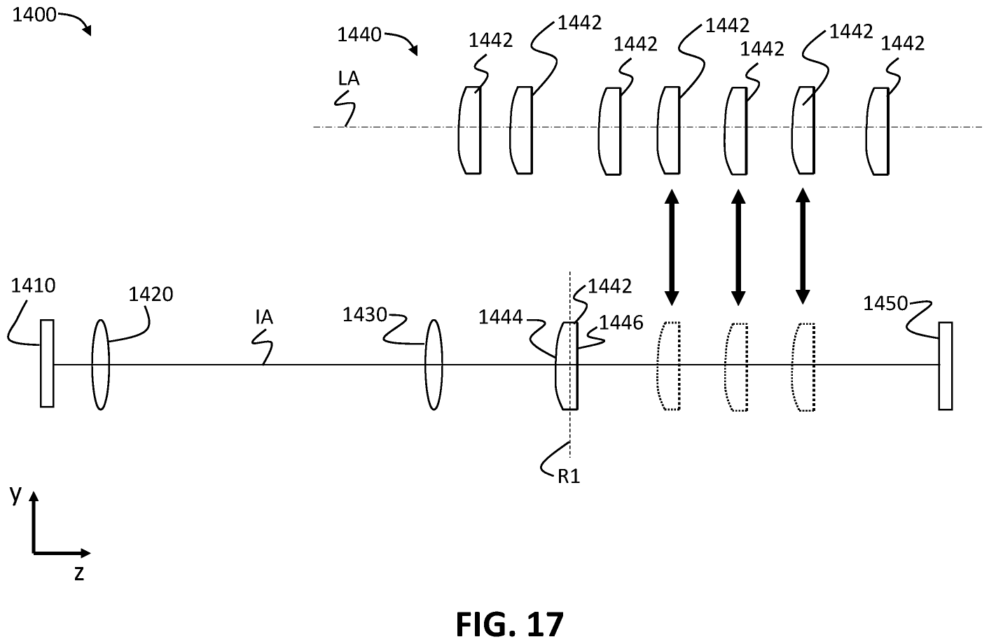

FIGS. 15A-15B show another example of how to address an image shift caused by movement of a single compensation plate. In particular, FIGS. 15A-15B show an arrangement (1200) that includes a flow cell (1210), an objective lens element (1220), a tube lens (1230), a compensation assembly (1240), a camera (1250), and a reflecting element (1260). Arrangement (1200) is configured and operable substantially similar to arrangement (1100). However, unlike camera (1150) of arrangement (1100), camera (1250) of arrangement is in a fixed position, with reflecting element (1260) being interposed between compensation plate (1242) of compensation assembly (1240) and camera (1250). Reflecting element (1260) reflects the light from compensation plate (1242) toward camera (1250). While camera (1250) is shown as facing along the y-dimension, this is just an example and camera (1250) may instead be oriented in any other suitable direction.

Like compensation plate (1142) of arrangement (1100), compensation plate (1242) of arrangement (1200) is configured to (by itself) compensate for any astigmatisms that may be provided by the combination of objective lens element (1220) and tube lens (1230). Similarly, compensation plate (1242) is rotatable about a pivot axis among different tilt angles (θ1, θ2) to adjust its own astigmatism, to thereby dynamically compensate for the thermally induced changes in the astigmatism of objective lens element (1220) as objective lens element (1220) heats up from an initial, resting temperature to a normal, stable operating temperature. Also like compensation plate (1142) of arrangement (1100), compensation plate (1242) of arrangement (1200) provides a shifted image axis (IA2) after compensation plate (1242) is pivoted.

In arrangement (1200) of the present example, the shift in the image axis (IA, IA2) is accounted for by movement of reflecting element (1260), such that reflecting element (1260) pivots about an axis that is parallel with the x-axis, to thereby redirect the light from compensation plate (1242) to ensure that the light continues to be centered on camera (1250). This pivotal movement of reflecting element (1260) is shown in the transition from FIG. 15A to FIG. 15B. Such movement of reflecting element (1260) may be provided in various ways. By way of example only, a dedicated actuator (not shown) may drive pivotal movement of reflecting element (1260). Such an actuator may be configured and operable in like any of the other actuators (970, 980, 1070) described herein. As another variation a single actuator (not shown) may be coupled with a linkage (not shown); and that linkage may be coupled with both compensation plate (1242) and reflecting element (1260). The combination of the actuator and the linkage may provide simultaneous, synchronized movement of compensation plate (1242) and reflecting element (1260). The linkage may be configured and operable similar to linkage (1080) described above. Alternatively, pivotal movement of compensation plate (1242) may be provided in any other suitable fashion; and pivotal movement of reflecting element (1260) may be provided in any other suitable fashion. In some variations, reflecting element (1260) is configured to deform rather than rotate, to controllably redirect light toward camera (1250).

As another example of a variation, reflecting element (1260) may translate along a path that is parallel to the z-axis. Such movement of reflecting element (1260) may move the image on the image sensor of camera (1250) to correct for offset induced by compensation plate (1242).

C. Example of Optical Arrangement with Deforming Compensation Element

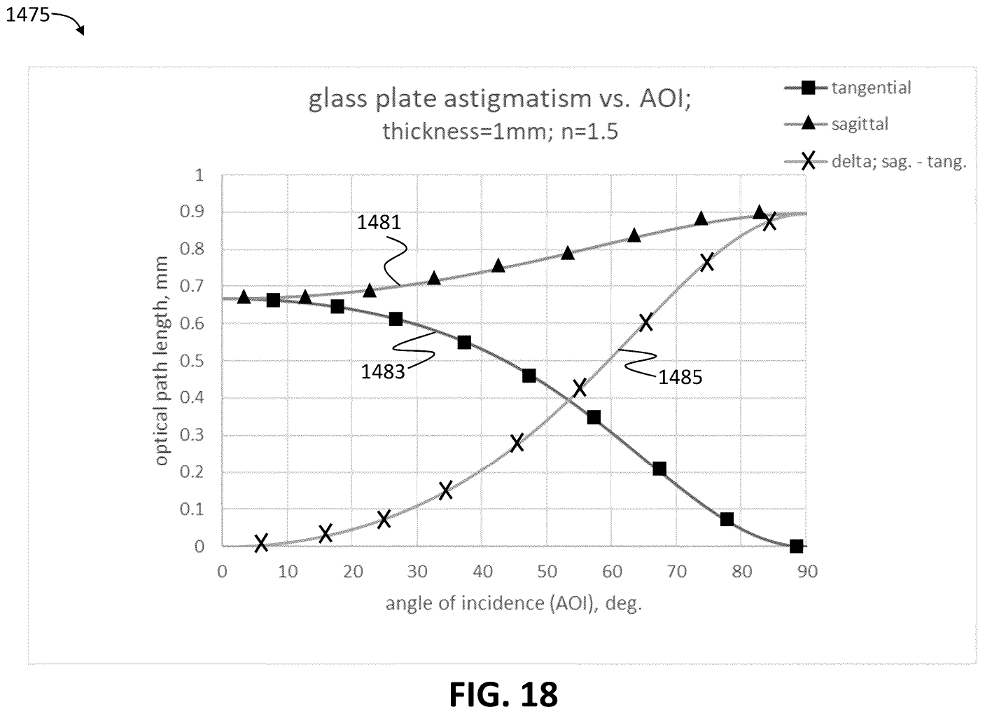

FIGS. 16A-16B show another example of an arrangement (1300) that may be integrated into imaging system (116, 310) or imaging assembly (522, 700). Arrangement (1300) of this example includes a flow cell (1310), an objective lens element (1320), a tube lens (1330), a compensation assembly (1340), and a camera (1350). Flow cell (1310), objective lens element (1320), tube lens (1330), and camera (1350) may be configured and operable like flow cell (810), objective lens element (820), tube lens (830), and camera (850) as described above. Compensation assembly (1340) may be configured and operable like compensation assembly (840), except as otherwise described below.

Compensation assembly (1340) of this example comprises a single compensation element (1342). Compensation element (1342) of this example is configured to selectively deform in response to a control signal. For instance, FIG. 16A shows compensation element (1342) in a substantially non-deformed state, where compensation element is substantially flat and positioned along a perpendicular reference plane (R1) that intersects the image axis (IA). FIG. 16B shows compensation element (1342) in a deformed state, where compensation element is deformed relative to the reference plane (R1). In the example shown, compensation element (1342) deforms along the z-dimension. In some versions, compensation element (1342) deforms along one or more other dimensions in addition to deforming along the z-dimension. By way of example only, compensation element (1342) may include a membrane and a plurality of electrodes, where the electrodes may be selectively activated to drive deformation of the membrane in a controlled fashion. Some such versions may be configured similar to a Delta 7 Phase Modulator by Phaseform GmbH of Freiburg, Germany. Some such deformable versions of compensation element (1342) may further include a liquid or gel. Alternatively, a deformable compensation element (1342) may take any other suitable form.

As compensation element (1342) deforms, an astigmatism induced by compensation element (1342) may change accordingly. Compensation element (1342) may thus be controllably deformed to thereby dynamically vary the astigmatism induced by compensation element (1342). This controlled deformation (and hence, varied astigmatism) may be provided in such a way to offset or compensate the astigmatism induced by the combination of objective lens element (1320) and tube lens (1342). Furthermore, as the astigmatism of objective lens element (1320) dynamically changes while objective lens element (1320) heats up from an initial, resting temperature to a normal, stable operating temperature, the deformation of compensation element (1342) may be adjusted accordingly, to “keep up” with the thermally induced dynamic aberration of objective lens element (1342) (i.e., dynamically correct for the thermally induced dynamic aberration of objective lens element (1342)) during the initial heating period.

It should be understood that a controller like controller (114, 308, 520) may be used to drive compensation element (1342) in accordance with any of the control schemes described herein. In other words, compensation element (1342) may be driven based on an ad hoc real-time feedback loop, based on a predetermined adjustment profile, or on any other suitable basis.

In the example shown in FIGS. 16A-16B, deformation of objective lens element (1342) does not cause any shifting of the image axis (IA). In some other variations, deformation of compensation element (1342) may cause any shifting of the image axis (IA). In such scenarios, camera (1350) may be moved to track the shifting image axis (IA) in a manner similar to that described above with reference to FIGS. 14A-14B. Alternatively, a movable reflective element may be interposed between compensation element (1342) and camera (1350), and that movable reflective element may be moved to track the shifting image axis (IA) in a manner similar to that described above with reference to FIGS. 15A-15B. Alternatively, any other suitable components and configurations may be used to account for shifting of the image axis (IA) caused by deformation of objective lens element (1342).

D. Example of Optical Arrangement with Cylindrical Compensation Element

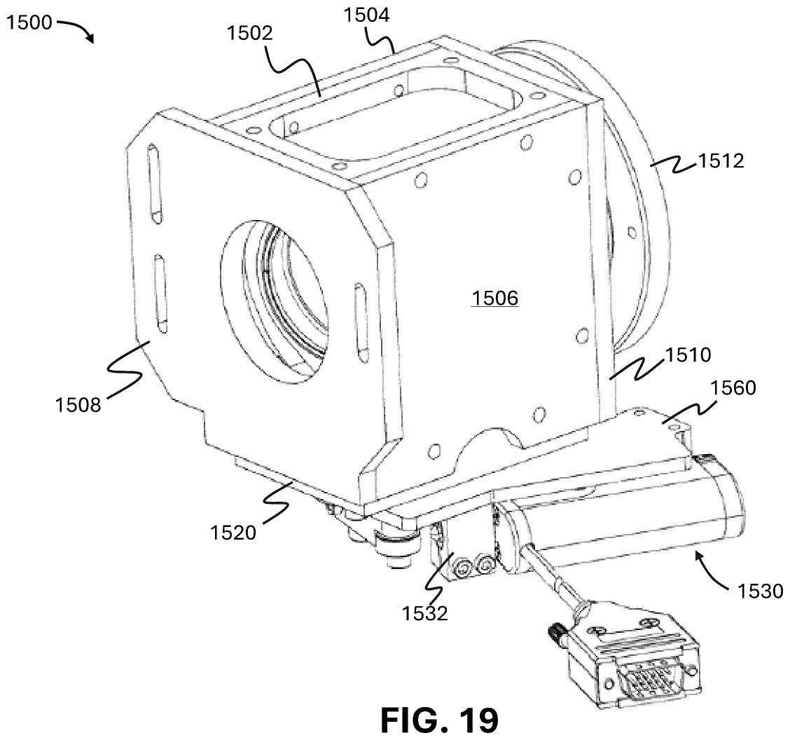

While the above-described example include flat plates and deformable members as examples of compensation elements (842, 844, 942, 944, 1042, 1044, 1142, 1242, 1342), other kinds of components may be used. For instance, FIG. 17 shows an example of an arrangement (1400) that includes a flow cell (1410), an objective lens element (1420), a tube lens (1430), a compensation assembly (1440), and a camera (1450). Flow cell (1410), objective lens element (1420), tube lens (1430), and camera (1450) may be configured and operable like flow cell (810), objective lens element (820), tube lens (830), and camera (850) as described above. Compensation assembly (1440) may be configured and operable like compensation assembly (840), except as otherwise described below.

Compensation assembly (1440) of this example comprises a plurality of compensation elements (1442). Each compensation element (1442) of this example is configured as a cylindrical lens element, with a convex surface (1444) facing tube lens (1430) and a flat surface (1446) facing camera (1450). Each compensation element (1442) may provide a discrete degree of astigmatism compensation. Each compensation element (1442) may also be selectively positioned in or away from the image axis (IA). Thus, while only one compensation element (1442) is shown as being positioned along the image axis (IA) in FIG. 17, other scenarios may provide two or more compensation elements (1442) positioned along the image axis (IA) simultaneously. In some versions, any compensation elements (1442) that are not positioned along the image axis (IA) may be positioned along a lateral axis (LA) that is laterally spaced away from the image axis (IA). Alternatively, any compensation elements (1442) that are not positioned along the image axis (IA) may be positioned and arranged in any other suitable fashion.

Since each compensation elements (1442) provides a discrete degree of astigmatism compensation in this example, compensation elements (1442) may be selectively aggregated along the image axis (IA) to provide a varying, collective degree of astigmatism compensation. For instance, when the combination of objective lens element (1420) and tube lens (1430) at the initial, lower temperature a first number of compensation elements (1442) may be positioned along the image axis (IA). As the temperature of objective lens element (1420) and tube lens (1430) increases during the initial stage of operation, with the thermally induced astigmatism of objective lens element (1420) varying accordingly, the number of compensation elements (1442) along the image axis (IA) may dynamically change to track the changing astigmatism of objective lens element (1420) until the combination of objective lens element (1420) and tube lens (1430) reach a steady operating temperature. In other words, compensation assembly (1440) may provide dynamically adjustable astigmatism compensation by selectively varying the number of compensation elements (1442) along the image axis (IA).

It should be understood that a controller like controller (114, 308, 520) may be used to drive movement of compensation elements (1442) in accordance with any of the control schemes described herein. In other words, compensation elements (1442) may be driven based on an ad hoc real-time feedback loop, based on a predetermined adjustment profile, or on any other suitable basis. It should also be understood that one or more actuators (not shown) may be utilized to drive such movement of compensation elements (1442). Such actuators may comprise pneumatic actuators, solenoids, voice coils, motorized rack and pinion assemblies, motorized crankshaft assemblies, and/or any other suitable components and arrangements. Moreover, compensation elements (1442) may be driven independently relative to each other, to thereby be positioned in or away from the image axis (IA).

As another variation of the example shown in FIG. 17, the different compensation elements (1442) compensation assembly (1440) may have different respective radii of curvature at curved surface (1444). Each compensation element (1442) may thus provide a degree of astigmatism compensation that differs from the astigmatism compensation provided by the other compensation elements (1442). In some such variations, just one compensation element (1442) may be positioned on the image axis (IA) at a given time, with such compensation element (1442) being selected based on the particular degree of astigmatism compensation provided by that particular compensation element (1442). However, there may be other scenarios where two or more compensation elements (1442) with different respective radii of curvature are selectively positioned along the image axis (IA) simultaneously to collectively provide a desired degree of astigmatism compensation.

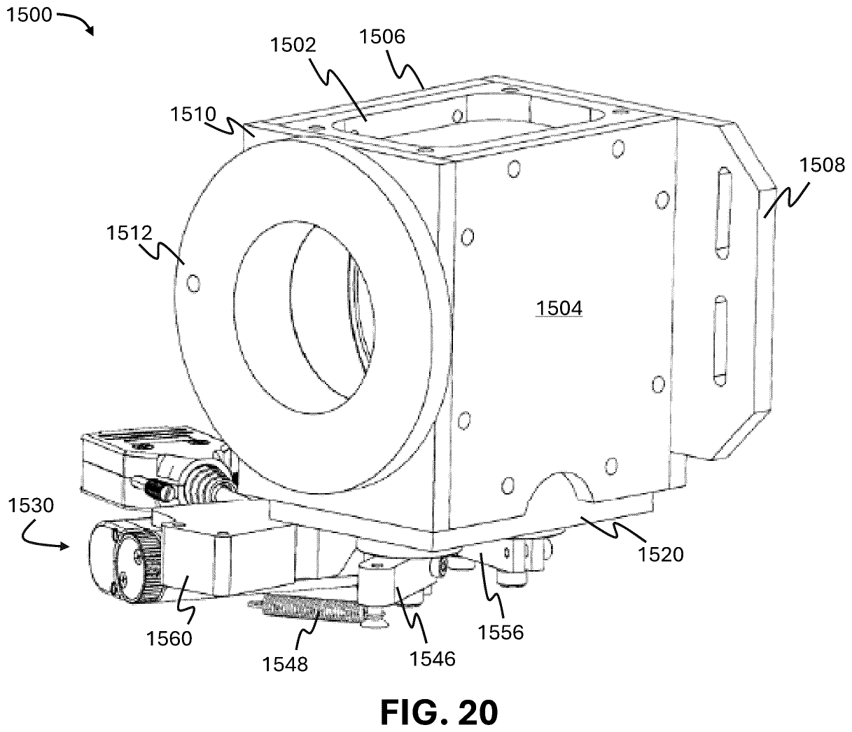

FIG. 18 shows an example of how the parameters of an astigmatism may vary as a function of angle of incidence with a compensation element (e.g., glass plate) such as the various compensation elements described herein. In particular, FIG. 18 shows a graph (1475) with a plot (1481) of effective optical path length along a sagittal plane, a plot (1483) of effective optical path length along a tangential plane, and a plot (1485) representing the difference between plots (1481, 1483). In the example depicted in FIG. 18, the thickness of the compensation element is 1 mm; and the index of refraction (n) is 1.5. In the tangential plane, the transfer matrix may be defined as follows, where t is the plate thickness, n is the refractive index and θ is the angle of incidence:

$$( \begin{matrix}1 & {tn}^{2} ( 1 - {sin}^{2} θ ) / {( {n}^{2} - {sin}^{2} θ )}^{3 / 2} \\ 0 & 1\end{matrix} )$$

While the transfer matrix for the sagittal plane may be defined as follows:

$$( \begin{matrix}1 & t / {( {n}^{2} - {sin}^{2} θ )}^{1 / 2} \\ 0 & 1\end{matrix} )$$

### VI. Example of Astigmatism Compensation Assembly with Housing Components and Actuation Assembly

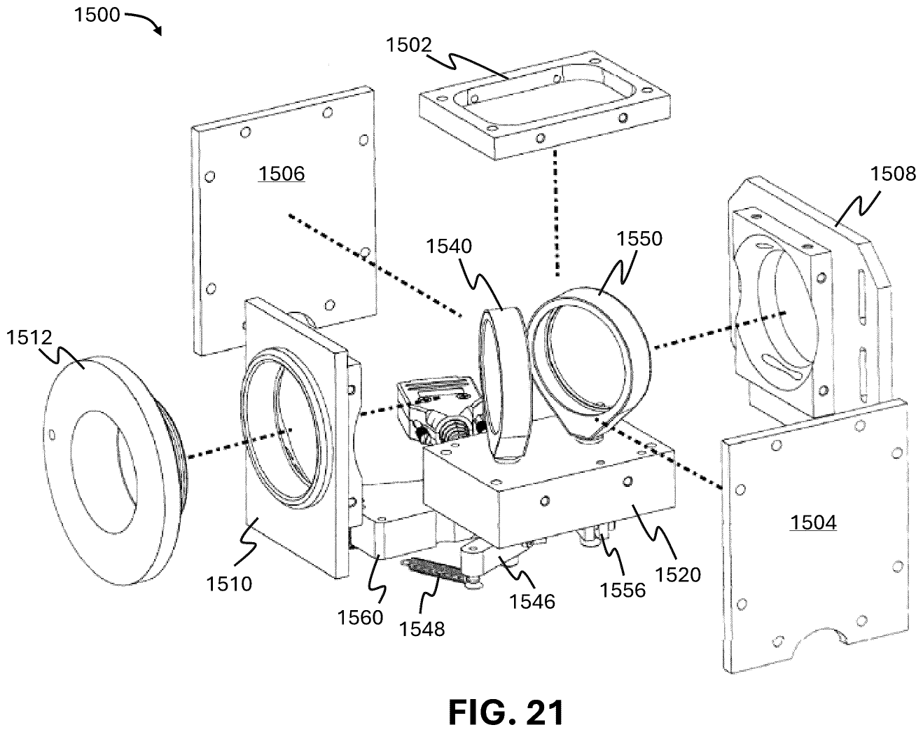

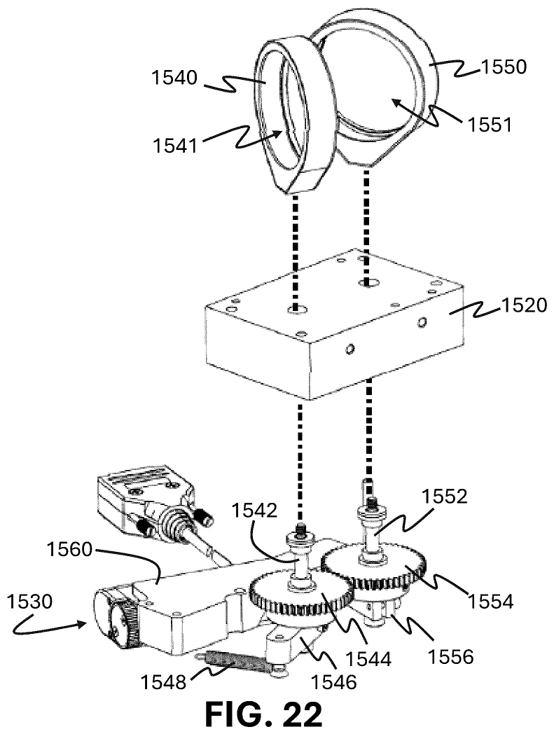

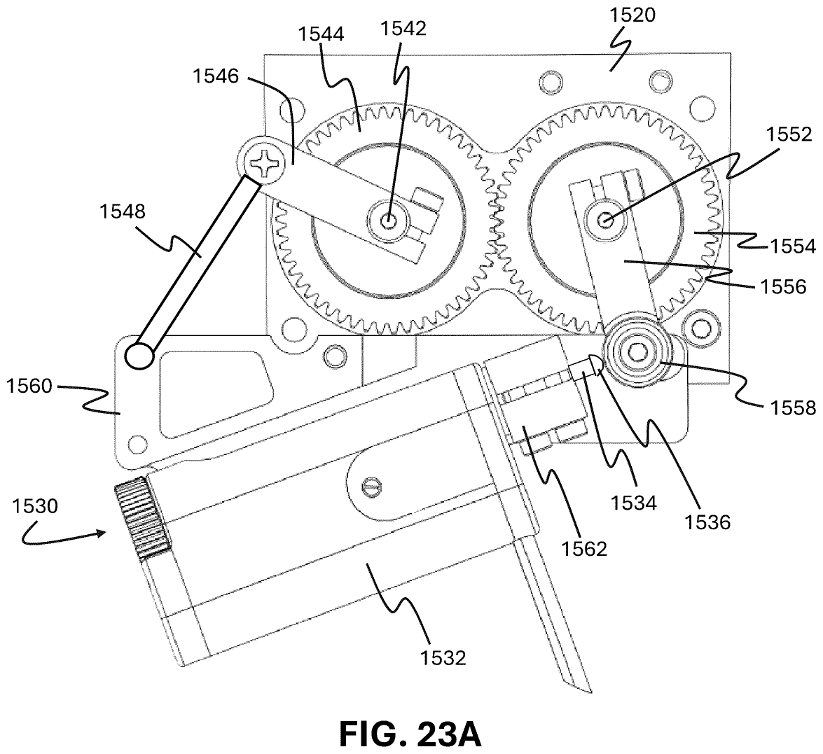

FIGS. 19-21 show an example of an astigmatism compensation assembly (1500) that may be incorporated into any of the various arrangements (800, 900, 1000, 1100, 1200) described above. For instance, compensation assembly (1500) of this example may represent a variation of compensation assembly (840); or more specifically, a variation of compensation assembly (1040). Compensation assembly (1500) of this example includes an upper housing element (1502), a first side housing element (1504), a second side housing element (1506), a third side housing element (1508), a fourth side housing element (1510), and a base plate (1520). Upper housing element (1502) is secured to upper ends of housing elements (1504, 1506, 1508, 1510). Lower ends of housing elements (1504, 1506, 1508, 1510) are secured to base plate (1520). Housing elements (1502, 1504, 1506, 1508, 1510) and base plate (1520) cooperate to form a box shape.

A ring element (1512) is coupled with fourth side housing element (1510). In some versions, ring element (1512) structurally facilitates physical coupling or integration of compensation assembly (1500) with other components of arrangement (800, 900, 1000, 1100, 1200). Ring element (1512) may also couple to fourth side housing element (1510) with a sliding seal ring to provide sealing from external light and contamination while allowing for axial length adjustment to match other system components.

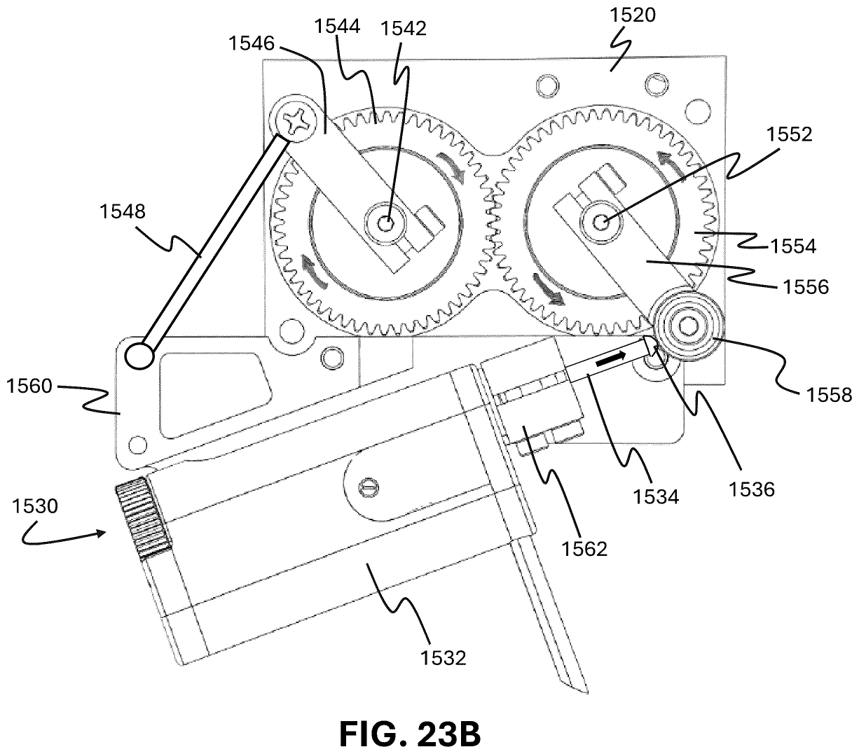

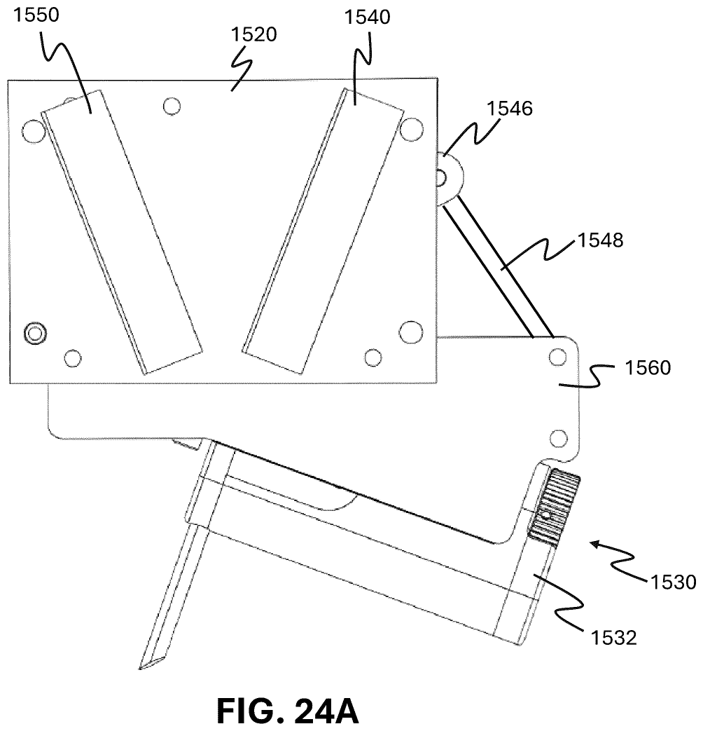

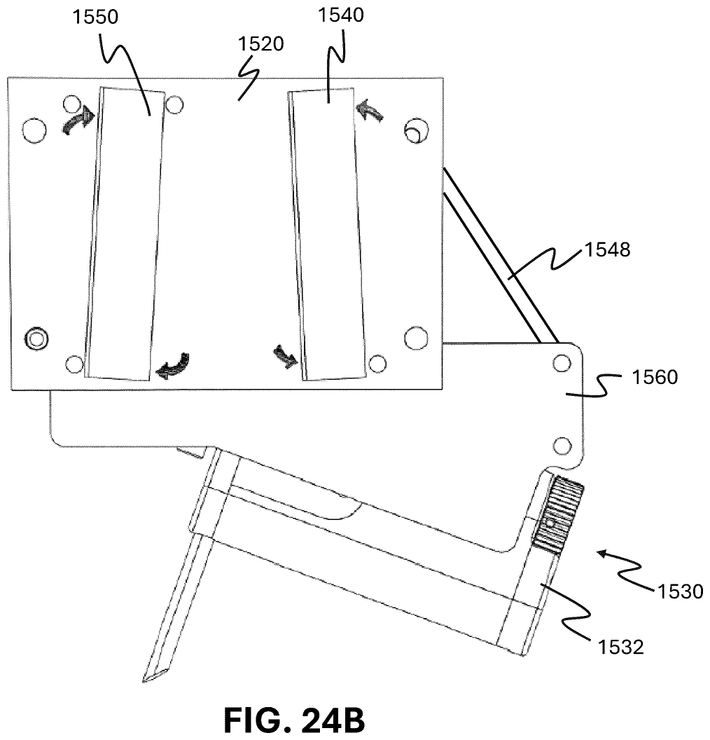

As shown in FIGS. 22-24B, compensation assembly (1500) further includes an actuator (1530) and a fixed frame plate (1560). Actuator (1530) comprises a body (1532) and a shaft (1534). Body (1532) is secured to fixed frame plate (1560) via a clamp assembly (1562). Actuator (1530) is operable to drive linear movement of shaft (1534) relative to body (1532) and relative to fixed frame plate (1560) as shown in the transition between FIG. 23A and FIG. 23B; and in the transition between FIG. 24A and FIG. 24B. In some versions, actuator (1530) includes a stepper motor coupled with a mechanical assembly (e.g., rack and pinion, screw gear and nut, etc.) that is operable to convert rotation of the motor shaft into linear movement of shaft (1534). Alternatively, actuator (1530) may take any other suitable form.

As also shown in FIGS. 22-24B, compensation assembly (1500) further includes a first frame (1540), a second frame (1550), a first rotary shaft (1542), a second rotary shaft (1552), a first gear (1544), a second gear (1554), a first crank arm (1546), and a second crank arm (1556). Each frame (1540, 1550) defines a respective opening (1541, 1551). Each opening (1541, 1551) is configured to receive a respective compensation plate (e.g., like compensation plates (842, 844, 942, 944, 1042, 1044) described above, etc.). Frames (1540, 1550), housing elements (1508, 1510), and ring element (1512) are configured and arranged such that light may pass through housing elements (1508, 1510), ring element (1512), and compensation plates that are disposed in openings (1541, 1551). In some versions, light enters compensation assembly (1500) via third side housing element (1508) and exits compensation assembly (1500) via ring element (1512) and fourth side housing element (1510). In some other versions, light enters compensation assembly (1500) via ring element (1512) and fourth side housing element (1510) and exits compensation assembly (1500) third side housing element (1508).

First frame (1540) is fixedly secured to first rotary shaft (1542), such that first frame (1540) and first rotary shaft (1542) rotate together unitarily. Similarly, second frame (1550) is fixedly secured to second rotary shaft (1552), such that second frame (1550) and second rotary shaft (1552) rotate together unitarily. Rotary shafts (1542, 1552) pass through base plate (1520) and are operable to rotate relative to base plate (1520). First rotary shaft (1542) is also fixedly secured to a first gear (1544) and one end of a first crank arm (1546). The other end of first crank arm (1546) is secured to one end of a coil spring (1548). Coil spring (1548) is shown schematically in FIGS. 23A-24B. The other end of coil spring (1548) is secured to fixed frame plate (1560). In the present example, coil spring (1548) may impart a resilient bias on crank arm (1546), thereby imparting a rotational resilient bias on first rotary shaft (1542), first gear (1544), and first frame (1540) (e.g., in the counterclockwise direction in the view shown in FIGS. 23A-23B. In some other versions, a torsion spring or other resilient element(s) impart(s) a rotational resilient bias on first rotary shaft (1542), first gear (1544), and first frame (1540). In still other versions, a rotational resilient bias is not imparted on first rotary shaft (1542), first gear (1544), and first frame (1540).

Second rotary shaft (1552) is fixedly secured to a second gear (1554) and one end of a second crank arm (1556). A roller bearing (1558) is secured to the other end of second crank arm (1556). Roller bearing (1558) is positioned to be engaged by a head (1536) at the end of shaft (1534) of actuator (1530). Thus, when actuator (1530) is activated to drive linear movement of shaft (1534), head (1536) bears against roller bearing (1558) such that the linear movement of shaft (1534) provides rotary movement of second gear (1554) via crank arm (1556). Gears (1544, 1554) are engaged with each other via meshing teeth, such that rotation of second gear (1554) in a first angular direction provides rotation of first gear (1544) in a second angular direction. This movement is shown in the transition between FIG. 23A and FIG. 23B.

As noted above, first frame (1540), first rotary shaft (1542), and first gear (1544) rotate together unitarily. As also noted above, second frame (1550), second rotary shaft (1552), and second gear (1554) rotate together unitarily. Thus, the rotational movement described above in the context of FIG. 23A and FIG. 23B also provide opposing angular movement of frames (1540, 1550). This opposing angular movement of frames (1540, 1550) is shown in the transition between FIG. 24A and FIG. 24B. With compensation elements secured within openings (1541, 1551) of frames (1540, 1550), this opposing angular movement of frames (1540, 1550) will provide the opposing angular movement of compensation elements as described above in the context of FIGS. 11A-13.

The resilient rotational bias provided to first gear (1544) by coil spring (1548) will be communicated to second gear (1554) via the meshing teeth of gears (1544. 1554). Thus, when shaft (1534) is retracted back toward body (1532), gears (1544, 1554), shafts (1542, 1544), and crank arms (1546, 1556) will back in the opposite direction from respective angular positions such as those shown in FIGS. 23B and 24B toward respective angular positions such as those shown in FIGS. 23A and 24A. Moreover, the resilient rotational bias imparted by coil spring (1548) on gears (1544. 1554) and crank arms (1546, 1556) will maintain contact between head (1536) and roller bearing (1558) as shaft (1534) is retracted back toward body (1532).

While not shown in FIGS. 19-24B, actuator (1530) may be coupled with a controller that is configured to control actuator (1530) to drive movement of frames (1540, 1550) (and, hence, the compensation elements secured within frames (1540, 1550)) in accordance with the teachings herein. Such a controller may be analogous to the various controllers (114, 308, 520, 960, 1060) described above.

### VII. Examples of Combinations

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

An apparatus, comprising: a sample stage region; an optical assembly including: an objective element providing a field of view, at least a portion of the sample stage region being within the field of view, the objective element having a variable astigmatism, a tube lens, the tube lens being configured to receive light transmitted through the objective element and further transmit the light through an image space, a compensating assembly in the image space, the compensating assembly being configured to induce a second astigmatism, the second astigmatism being configured to offset the variable astigmatism; and a camera assembly configured to receive light transmitted from the compensating assembly.

### Example 2

The apparatus of Example 1, the compensating assembly being operable to vary the second astigmatism to thereby dynamically offset the variable astigmatism of the objective element.

### Example 3

The apparatus of Example 2, further comprising a processor, the processor being operable to control the compensating assembly to thereby vary the second astigmatism.

### Example 4

The apparatus of Example 3, the processor being operable to control the compensating assembly to thereby vary the second astigmatism based on a predetermined adjustment profile.

### Example 5

The apparatus of Example 3, the processor being operable to determine an astigmatism value of the objective element.

### Example 6

The apparatus of Example 5, the processor being operable to control the compensating assembly to thereby vary the second astigmatism based on the determined astigmatism value of the objective element.

### Example 7

The apparatus of any of Examples 1 through 6, the compensating assembly comprising a first optically transmissive plate and a second optically transmissive plate.

### Example 8

The apparatus of Example 7, the first optically transmissive plate being tilted at a first angle about a first axis, the second optically transmissive plate being tilted at a second angle about a second axis.

### Example 9

The apparatus of Example 8, the first optically transmissive plate and the second optically transmissive plate being positioned along an image axis, the first axis being orthogonal to the image axis, the second axis being parallel with the first axis.

### Example 10

The apparatus of any of Examples 8 through 9, the first angle having a magnitude and direction equal and opposite to a magnitude and direction, respectively, of the second angle.

### Example 11

The apparatus of any of any of Examples 8 through 10, the compensating assembly further comprising a first actuator, the first actuator being operable to drive movement of one or both of the first optically transmissive plate about the first axis or the second optically transmissive plate about the second axis.

### Example 12

The apparatus of Example 11, the compensating assembly further comprising a linkage, the first actuator and the linkage being configured to cooperate to drive movement of the first optically transmissive plate about at the first axis and the second optically transmissive plate about the second axis concomitantly.

### Example 13

The apparatus of Example 11, the compensating assembly further comprising a second actuator, the first actuator being coupled with the first optically transmissive plate to thereby drive movement of the first optically transmissive plate about at the first axis, the second actuator being coupled with the second optically transmissive plate to thereby drive movement of the second optically transmissive plate about at the second axis.

### Example 14

The apparatus of any of Examples 11 through 13, the first actuator comprising a motor.

### Example 15

The apparatus of any of Examples 11 through 14, the compensating assembly further comprising a first gear and a second gear, the first optically transmissive plate to rotate unitarily with the first gear, the second optically transmissive plate to rotate unitarily with the second gear.

### Example 16

The apparatus of Example 15, the first gear being positioned to mesh directly with the second gear.

### Example 17

The apparatus of any of Examples 15 through 16, the compensating assembly further comprising a crank arm coupled with the first gear, the first actuator to drive rotary motion of the crank arm, the crank arm to drive rotary motion of the first gear.

### Example 18

The apparatus of any of Examples 11 through 17, the compensating assembly further including housing elements forming a box around the first optically transmissive plate and the second optically transmissive plate.

### Example 19

The apparatus of any of Examples 11 through 18, the compensating assembly further comprising a first shaft, a second shaft, and a base plate, the first shaft and the second shaft passing through the base plate, the first shaft to drive movement of the first optically transmissive plate about the first axis, the second shaft to drive movement of the second optically transmissive plate about the second axis.

### Example 20

The apparatus of any of Examples 1 through 6, the compensating assembly comprising a first optically transmissive element and a reflective element.

### Example 21

The apparatus of any of Examples 1 through 20, the compensating assembly comprising a deformable element.

### Example 22

The apparatus of Example 21, the deformable element being optically transmissive.

### Example 23

The apparatus of Example 21, the deformable element being reflective.

### Example 24

The apparatus of any of Examples 1 through 23, further comprising a heating element, the heating element being operable to heat the objective element and thereby vary the astigmatism of the objective element.

### Example 25

The apparatus of Example 24, the heating element comprising a source of laser light.

### Example 26

An apparatus, comprising: a sample stage region; an optical assembly including: an objective element providing a field of view, at least a portion of the sample stage region being within the field of view, the objective element having an astigmatism that is variable based on a temperature of the objective element, a tube lens, the tube lens being configured to receive light transmitted through the objective element and further transmit the light through an image space, a first compensating element in the image space, the first compensating element being configured to induce a second astigmatism, a second compensating element in the image space, the second compensating element being configured to induce a third astigmatism, the second and third astigmatisms being configured to cooperate to offset the variable astigmatism; and a camera assembly configured to receive light transmitted from the compensating assembly.

### Example 27

The apparatus of Example 26, the first compensating element being titled at a first angle, the second compensating element being tilted at a second angle that is equal and opposite to the first angle.

### Example 28

The apparatus of any of Examples 26 through 27, the first compensating element being movable relative to the objective element to adjust the second astigmatism, the second compensating element being movable relative to the objective element to adjust the third astigmatism.

### Example 29

The apparatus of Example 28, further comprising a controller, the controller being configured to drive movement of the first compensating element and the second compensating element to track thermally induced changes in the astigmatism of the objective element.

### Example 30

The apparatus of Example 29, the controller being further configured to track the thermally induced changes in the astigmatism of the objective element.

### Example 31

The apparatus of Example 30, the controller being configured to process images captured by the camera assembly, the controller being further configured to determine and track the thermally induced changes in the astigmatism of the objective element based on the processed images.

### Example 32

The apparatus of any of Examples 29 through 31, the controller being configured to drive movement of the first compensating element and the second compensating element based on a predetermined adjustment profile.

### Example 33

The apparatus of Example 32, the controller being configured to define the predetermined adjustment profile.

### Example 34

The apparatus of Example 33, the controller being configured to execute a calibration routine and define the predetermined adjustment profile through the calibration routine.

### Example 35

The apparatus of any of Examples 26 through 34, the sample stage region being configured to receive a flow cell.

### Example 36

A method comprising: receiving light from a reaction site through an objective element, the objective element having an astigmatism, the light passing further through a compensation assembly, the compensation assembly providing a compensating astigmatism, the compensating astigmatism offsetting the astigmatism of the objective element; heating the objective element, the astigmatism of the objective element changing in response to the heating; and adjusting the compensation assembly to thereby change the compensating astigmatism, thereby offsetting the changing astigmatism of the objective element.

### Example 37

The method of Example 36, further comprising irradiating the reaction site with excitation light.

### Example 38

The method of Example 37, the excitation light passing through the objective element to reach the reaction site.

### Example 39

The method of Example 38, the excitation light causing the heating of the objective element.

### Example 40

The method of any of Examples 37 through 39, the excitation light comprising laser light.

### Example 41

The method of any of Examples 36 through 40, the compensation assembly comprising a first compensating element, the act of adjusting the compensation assembly comprising pivoting the first compensating element in a first angular direction about a first pivot axis through a first pivotal range of motion.

### Example 42

The method of Example 41, the compensation assembly further comprising a second compensating element, the act of adjusting the compensation assembly further comprising pivoting the second compensating element in a second angular direction about a second pivot axis through a second pivotal range of motion.

### Example 43

The method of Example 42, the second angular direction being opposite to the first angular direction.

### Example 44

The method of any of Examples 42 through 43, the second pivot axis being parallel with the first pivot axis.

### Example 45

The method of any of Examples 42 through 44, the second pivotal range of motion being equal to the first pivotal range of motion.

### Example 46

The method of Example 41, an image axis of the light shifting in response to pivoting the first compensating element in a first angular direction about a first pivot axis through a first pivotal range of motion, the method further comprising moving a camera based on the shifting of the image axis of the light, the camera capturing at least some of the light.

### Example 47

The method of Example 41, an image axis of the light shifting in response to pivoting the first compensating element in a first angular direction about a first pivot axis through a first pivotal range of motion, the method further comprising moving a reflecting element based on the shifting of the image axis of the light.

### Example 48

The method of Example 47, the act of moving the reflecting element comprising pivoting the reflecting element.

### Example 49

The method of any of Examples 47 through 48, the act of moving the reflecting element comprising deforming the reflecting element.

### Example 50

The method of any of Examples 47 through 49, the reflecting element redirecting the light toward a camera.

### Example 51

The method of Example 50, the camera maintaining a fixed position during movement of the reflecting element.

### Example 52

The method of any of Examples 36 through 40, the compensation assembly comprising a deformable compensating element, the act of adjusting the compensation assembly comprising deforming the compensating element.

### Example 53

The method of Example 52, the light being emitted along an image axis, the act of deforming the compensating element comprising deforming the compensating element along the image axis.

### Example 54

The method of any of Examples 36 through 53, further comprising capturing the light with a camera, the compensation assembly being interposed between the objective element and the camera.

### Example 55

The method of any of Examples 36 through 53, further comprising performing sequencing by synthesis.

### VIII. Miscellaneous

While the foregoing examples are provided in the context of a system (100) that may be used in nucleotide sequencing processes, the teachings herein may also be readily applied in other contexts, including in systems that perform other processes (i.e., other than nucleotide sequencing procedures). The teachings herein are thus not necessarily limited to systems that are used to perform nucleotide sequencing processes.

It is to be understood that the subject matter described herein is not limited in its application to the details of construction and the arrangement of components set forth in the description herein or illustrated in the drawings hereof. The subject matter described herein is capable of other implementations and of being practiced or of being carried out in various ways. Also, it is to be understood that the phraseology and terminology used herein is for the purpose of description and should not be regarded as limiting. As used herein, an element or step recited in the singular and proceeded with the word “a” or “an” should be understood as not excluding plural of said elements or steps, unless such exclusion is explicitly stated. Furthermore, references to “one example” are not intended to be interpreted as excluding the existence of additional examples that also incorporate the recited features. The use of “including,” “comprising,” or “having” and variations thereof herein is meant to encompass the items listed thereafter and equivalents thereof as well as additional items.

When used in the claims, the term “set” should be understood as one or more things which are grouped together. Similarly, when used in the claims “based on” should be understood as indicating that one thing is determined at least in part by what it is specified as being “based on.” Where one thing is required to be exclusively determined by another thing, then that thing will be referred to as being “exclusively based on” that which it is determined by.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Also, it is to be understood that phraseology and terminology used herein with reference to device or element orientation (such as, for example, terms like “above,” “below,” “front,” “rear,” “distal,” “proximal,” and the like) are only used to simplify description of one or more examples described herein, and do not alone indicate or imply that the device or element referred to must have a particular orientation. In addition, terms such as “outer” and “inner” are used herein for purposes of description and are not intended to indicate or imply relative importance or significance.

It is to be understood that the above description is intended to be illustrative, and not restrictive. For example, the above-described examples (and/or aspects thereof) may be used in combination with each other. In addition, many modifications may be made to adapt a particular situation or material to the teachings of the presently described subject matter without departing from its scope. While the dimensions, types of materials and coatings described herein are intended to define the parameters of the disclosed subject matter, they are by no means limiting and instead illustrations. Many further examples will be apparent to those of skill in the art upon reviewing the above description. The scope of the disclosed subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) paragraph, unless and until such claim limitations expressly use the phrase “means for” followed by a statement of function void of further structure.

The following claims recite aspects of certain examples of the disclosed subject matter and are considered to be part of the above disclosure. These aspects may be combined with one another.

What is claimed is:

1. An apparatus, comprising:
a sample stage region;
an optical assembly including:
an objective element providing a field of view, at least a portion of the sample stage region being within the field of view, the objective element having a variable astigmatism,
a tube lens, the tube lens being configured to receive light transmitted through the objective element and further transmit the light through an image space,
a compensating assembly in the image space, the compensating assembly being configured to induce a second astigmatism, the second astigmatism being configured to offset the variable astigmatism; and
a camera assembly configured to receive light transmitted from the compensating assembly.

2. The apparatus of claim 1, the compensating assembly being operable to vary the second astigmatism to thereby dynamically offset the variable astigmatism of the objective element.

3. The apparatus of claim 2, further comprising a processor, the processor being operable to control the compensating assembly to thereby vary the second astigmatism.

4. The apparatus of claim 3, the processor being operable to control the compensating assembly to thereby vary the second astigmatism based on a predetermined adjustment profile.

5. The apparatus of claim 3, the processor being operable to determine an astigmatism value of the objective element.

6. The apparatus of claim 5, the processor being operable to control the compensating assembly to thereby vary the second astigmatism based on the determined astigmatism value of the objective element.

7. The apparatus of claim 1, the compensating assembly comprising a first optically transmissive plate and a second optically transmissive plate.

8. The apparatus of claim 7, the first optically transmissive plate being tilted at a first angle about a first axis, the second optically transmissive plate being tilted at a second angle about a second axis.

9. The apparatus of claim 8, the first optically transmissive plate and the second optically transmissive plate being positioned along an image axis, the first axis being orthogonal to the image axis, the second axis being parallel with the first axis.

10. The apparatus of claim 8, the compensating assembly further comprising a first actuator, the first actuator being operable to drive movement of one or both of the first optically transmissive plate about the first axis or the second optically transmissive plate about the second axis.

11. The apparatus of claim 10, the compensating assembly further comprising a linkage, the first actuator and the linkage being configured to cooperate to drive movement of the first optically transmissive plate about at the first axis and the second optically transmissive plate about the second axis concomitantly.

12. The apparatus of claim 10, the compensating assembly further comprising a second actuator, the first actuator being coupled with the first optically transmissive plate to thereby drive movement of the first optically transmissive plate about at the first axis, the second actuator being coupled with the second optically transmissive plate to thereby drive movement of the second optically transmissive plate about at the second axis.

13. The apparatus of claim 11, the first actuator comprising a motor.

14. The apparatus of claim 10, the compensating assembly further comprising a first gear and a second gear, the first optically transmissive plate to rotate unitarily with the first gear, the second optically transmissive plate to rotate unitarily with the second gear.

15. The apparatus of claim 14, the compensating assembly further comprising a crank arm coupled with the first gear, the first actuator to drive rotary motion of the crank arm, the crank arm to drive rotary motion of the first gear.

16. The apparatus of claim 1, the compensating assembly comprising a first optically transmissive element and a reflective element.

17. The apparatus of claim 1, the compensating assembly comprising a deformable element, the deformable element being optically transmissive or reflective.

18. The apparatus of claim 1, further comprising a heating element, the heating element being operable to heat the objective element and thereby vary the astigmatism of the objective element.

19. An apparatus, comprising:
a sample stage region;
an optical assembly including:
an objective element providing a field of view, at least a portion of the sample stage region being within the field of view, the objective element having an astigmatism that is variable based on a temperature of the objective element,
a tube lens, the tube lens being configured to receive light transmitted through the objective element and further transmit the light through an image space,
a first compensating element in the image space, the first compensating element being configured to induce a second astigmatism,
a second compensating element in the image space, the second compensating element being configured to induce a third astigmatism, the second and third astigmatisms being configured to cooperate to offset the variable astigmatism; and
a camera assembly configured to receive light transmitted from the compensating assembly.

20. A method comprising:
receiving light from a reaction site through an objective element, the objective element having an astigmatism, the light passing further through a compensation assembly, the compensation assembly providing a compensating astigmatism, the compensating astigmatism offsetting the astigmatism of the objective element;
heating the objective element, the astigmatism of the objective element changing in response to the heating; and
adjusting the compensation assembly to thereby change the compensating astigmatism, thereby offsetting the changing astigmatism of the objective element.
